(19) United States
(12) Patent Application Publication
(10) Pub. No.: US 2012/0089895 A1
(43) Pub. Date: Apr. 12, 2012

(54) MOBILE TERMINAL DEVICE AND RECORDING MEDIUM

(75) Inventor: Kenji ISHII, Kawasaki (JP)

(73) Assignee: FUJITSU LIMITED, Kawasaki-shi (JP)

(21) Appl. No.: 13/252,701

(22) Filed: Oct. 4, 2011

(30) Foreign Application Priority Data
Oct. 6, 2010 (JP) 2010-227011

(51) Int. Cl. G06F 17/00

(52) U.S. Cl. 715/205

(57) ABSTRACT

A mobile terminal device has a control unit and a display unit. The control unit executes a process which includes acquiring data having anchors that are link information that is linked to other data, specifying an anchor that is included in a display range among the acquired anchors, editing data that is to be displayed and includes the specified anchor to which a shortcut is assigned and making the display unit display the edited data.

### CROSS-REFERENCE TO RELATED APPLICATIONS

This application is based upon and claims the benefit of priority of the prior Japanese Patent Application No. 2010-227011, filed on Oct. 6, 2010, the entire contents of which are incorporated herein by reference.

### FIELD

The embodiment discussed herein is related to a technique for supporting a selection of link information displayed on a screen of a mobile terminal device such as a mobile phone.

### BACKGROUND

The following mechanism (link) is known. When a user selects link information that is included in data (such as an HTML file) displayed on a screen and described in a markup language that can be interpreted and displayed by a browser program, the mechanism (link) causes the user to jump to a web (world wide web) page assigned to the link information or a file assigned to the link information. The link information that is the source of the link destination and indicates the link destination is called an anchor.

For a browser, a shortcut function and an easy focus function are known. The shortcut function is a function that can select an anchor of hypertext markup language (HTML) or extensible HTML (XHTML) by selecting and pressing an interested number key from a numeric keypad. This function is achieved by shortcut information expressly described in an HTML content by a content creator (for example, <a href=“jump.htm” accesskey=“1”> jump </a>).

A technique for assigning shortcuts corresponding to numbers (0 to 9) of a numeric keypad to anchors of a content to which shortcut information is not assigned is disclosed in Japanese Laid-open Patent Publication No. 2003-006097.

The technique described in the aforementioned patent document assigns shortcuts corresponding to 10 numbers (0 to 9) to anchors included in a downloaded HTML file and displays the anchors and the shortcuts on a browser. The patent document does not describe that when an HTML file that includes 11 or more anchors is used, shortcuts are assigned to the eleventh and later anchors. For example, when the first 10 anchors are displayed on a screen immediately after the downloading and the screen is scrolled down, only the eleventh and later anchors to which shortcuts are not assigned are displayed on the next displayed screen. Thus, the user may not use the shortcut function in some cases depending on the relationship between contents of the HTML file and the state of the displayed screen. This applies not only to the scrolling of the screen but also the case of an enlarged screen.

In addition, among the anchors, there is an anchor that uses a NAME tag and causes a specified portion of an HTML file (instead of a head portion of the HTML file) to be displayed at the head of a screen. Even in this case, when the specified portion is any of the eleventh and later anchors to which shortcuts are not applied, the same applies to the eleventh and later anchors. Specifically, the anchors that are displayed on the screen do not have shortcuts assigned thereto.

### SUMMARY

According to an aspect of the embodiment, a mobile terminal device has a control unit and a display unit. The control unit executes a process which includes acquiring data having anchors that are link information that is linked to other data, specifying an anchor that is included in a display range among the acquired anchors, editing data that is to be displayed and includes the specified anchor to which a shortcut is assigned and making the display unit display the edited data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a mobile terminal device according to a first embodiment.

FIG. 2 is a flowchart of an example of procedures of a process that is performed on data to be displayed.

FIG. 3 is a diagram illustrating an example of a functional configuration of a mobile terminal device according to a second embodiment.

FIG. 4 is a diagram illustrating an example of an event processor.

FIG. 5 is a diagram illustrating an example of hardware of the mobile terminal device.

FIG. 6 is a diagram illustrating an example of the mobile terminal device.

FIG. 7 is a diagram illustrating an example of a display screen of the mobile terminal device.

FIGS. 8A to 8C are diagrams illustrating an example of an HTML content displayed on a content display screen.

FIG. 9 is a diagram illustrating an example of the display screen to which shortcut numbers are added.

FIG. 10 is a diagram illustrating an example of the display screen to which the shortcut numbers are added after scrolling of the screen.

FIGS. 11A to 11C are diagrams illustrating an example of an object model variable table and the display screen.

FIGS. 12A to 12E are diagrams illustrating an example of the object model variable table, an anchor object table and an HTML content.

FIGS. 13A to 13D are diagrams illustrating an example of the object model variable table, the anchor object table, a shortcut object table and the display screen before scrolling of the screen.

FIGS. 14A to 14D are diagrams illustrating an example of the object model variable table, the anchor object table, the shortcut object table and the display screen after the scrolling of the screen.

FIG. 15 is a diagram illustrating a part that is included in the object model variable table and used to draw the shortcut numbers.

FIG. 16 is a flowchart of an example of procedures of a process that is performed on coordinate positions of a shortcut.

FIG. 17 is a diagram illustrating an example of the display screen on which the coordinate positions of the shortcut are indicated.

FIG. 18 is an enlarged diagram illustrating the coordinate positions of the shortcut.

FIG. 19 is a diagram illustrating an example of the display screen on which corrected coordinate positions of the shortcut are indicated.

FIG. 20 is an enlarged diagram illustrating the corrected coordinate positions of the shortcut.

FIG. 21 is a flowchart of an example of procedures of an acquisition of an HTML file, an analysis of the HTML file and a drawing process.

FIG. 22 is a flowchart of an example of procedures of the HTML analysis process.

FIGS. 23A and 23B are flowcharts of an example of procedures of the drawing process.

FIG. 24 is a flowchart of an example of procedures of a process of setting an anchor object.

FIG. 25 is a flowchart of an example of procedures of a process of assigning a shortcut.

FIG. 26 is a flowchart of an example of procedures of a process of calculating a display order.

FIG. 27 is a flowchart of an example of procedures of a process of drawing the shortcut numbers.

FIGS. 28A to 28C are flowcharts of an example of procedures of a process that is performed in an event waiting state.

FIGS. 29A and 29B are flowcharts of an example of procedures of a drawing process.

FIGS. 30A and 30B are flowcharts of an example of procedures of a redrawing process that is performed in order to draw the shortcut numbers.

FIG. 31A is a diagram illustrating an example of a shortcut drawing unit according to a third embodiment.

FIG. 31B is a diagram illustrating an example of an operation input unit according to the third embodiment.

FIG. 32 is a diagram illustrating an example of the display screen on which content is displayed before switching and to which shortcut numbers are added.

FIG. 33 is a diagram illustrating an example of the display screen on which the content is displayed after switching and to which the shortcut numbers are added.

FIG. 34 is a diagram illustrating an example of the display screen on which the content is displayed after re-switching and to which the shortcut numbers are added.

FIG. 35 is a flowchart of an example of procedures of a process of switching assignments of the shortcut numbers.

FIG. 36 is a flowchart of an example of procedures of a process according to another embodiment.

FIG. 37 is a flowchart of an example of procedures of a drawing process according to the other embodiment.

FIG. 38 is a diagram illustrating an example of a PDA according to the other embodiment.

### DESCRIPTION OF EMBODIMENTS

### First Embodiment

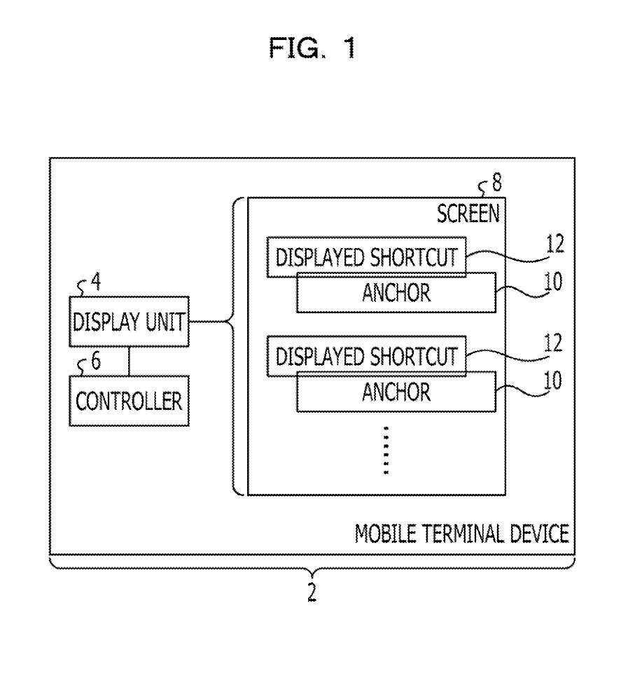

FIG. 1 illustrates an example of a mobile terminal device. A mobile terminal device 2 is an example of a mobile terminal device disclosed herein. In addition, the mobile terminal device 2 is an example of a recording medium disclosed herein.

The mobile terminal device 2 includes a display unit 4 and a controller 6. The display unit 4 is an example of means for displaying data (to be displayed) edited by the controller 6. The display unit 4 displays link information on a screen 8. The link information indicates a link destination included in data (such as an HTML file) described in a markup language that can be interpreted and displayed by a browser program. A plurality of anchors 10 are displayed on the screen 8. Link destinations are assigned to the anchors 10. The link destinations are underlined or surrounded by frames in order to distinguish between the link destinations and other displayed information. Each of the anchors 10 is an example of link information that indicates a link destination. At least one of a web site, a different page within the web site, a different section within the web page, a file other than HTML/XHTML files and an electronic mail address is included in each of the link destinations. The anchors 10 are displayed using signs (such as characters), figures or the like, for example.

The controller 6 serves as means for acquiring data. The controller 6 also serves as means for specifying an anchor. The controller 6 also serves as means for editing data to be displayed. The controller 6 has a function of generating a shortcut and a function of displaying the shortcut. The data acquiring means acquires data that includes anchors that are link information that is linked to other data. The anchor specifying means specifies an anchor that is included in a display range among the anchors included in the acquired data. The data editing means edits data that is to be displayed and includes the specified anchor to which a shortcut is assigned. The shortcut generating function automatically generates shortcuts that correspond to the anchors 10 that are examples of link information. The controller 6 automatically generates information on the shortcuts for the anchors 10 on the basis of the screen 8 displayed on the display unit 4. The shortcut display function assigns shortcuts 12 to the anchors 10 displayed on the screen 8 of the display unit 4 and displays the anchors 10 and the shortcuts 12.

In the present embodiment, the shortcuts 12 are displayed by the controller 6 on the screen 8 of the display unit 4. The shortcuts 12 are assigned to the displayed anchors 10 on the basis of the screen 8 displayed on the display unit 4. The shortcuts 12 and the anchors 10 are displayed so that parts of the shortcuts 12 overlap the anchors 10, respectively. In this case, the shortcuts 12 are displayed so that the shortcuts 12 include signs that correspond to numbers of a numeric keypad, for example. In addition, the shortcuts 12 may be displayed using a different font type from the anchors 10, a different color from the anchors 10, different brightness from the anchors 10, or different luminescence from the anchors 10 in order to distinguish between the shortcuts 12 and displayed information of the anchors 10.

In this configuration, when the anchors 10 that indicate link destinations are displayed on the screen 8 of the display unit 4, the shortcuts are automatically generated in response to the display of the screen, and the shortcuts 12 are assigned to the anchors 10 displayed on the screen 8. The anchors 10 can be specified on the basis of the shortcuts 12. The anchors 10 can be operated by operating the numeric keypad that is assigned to the shortcuts 12, for example.

When the screen 8 is scrolled, the shortcuts are not assigned to the anchors in order from an anchor that corresponds to a head portion of target data. When the screen 8 is scrolled, the shortcuts are automatically generated for anchors 10 actually displayed on the screen 8 and are assigned to the displayed anchors 10. As a result, a lot of shortcuts can be assigned.

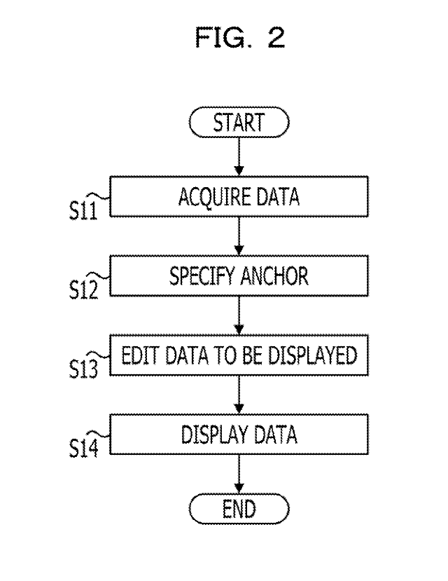

FIG. 2 illustrates an example of procedures of a process that is performed on data to be displayed.

The process procedures are an example of an information selection support program of the mobile terminal device disclosed herein. As illustrated in FIG. 2, in the process procedures, a process (step S11) of acquiring data, a process (step S12) of specifying an anchor, a process (step S13) of editing data to be displayed and a process (step S14) of displaying the data (to be displayed) are performed. The process illustrated in FIG. 2 includes a process of generating shortcuts and a process of displaying the shortcuts.

In the process (step S11) of acquiring data, a processor (described later) acquires data that includes anchors that are link information that is linked to other data. In the process (step S12) of specifying an anchor, the processor specifies, among the anchors included in the acquired data, an anchor that is included in a display range. In the process (step S13) of editing data to be displayed, the processor edits data that is to be displayed and includes the specified anchor to which a shortcut is assigned. In the process (step S14) of displaying the data (to be displayed), the processor displays the edited data (to be displayed) on the display unit 4.

According to the first embodiment, since the shortcuts are assigned to the anchors 10 that are displayed on the screen 8, shortcuts can be assigned to a lot of anchors. Thus, it is possible to improve convenience of a selection of information using shortcut keys.

### Second Embodiment

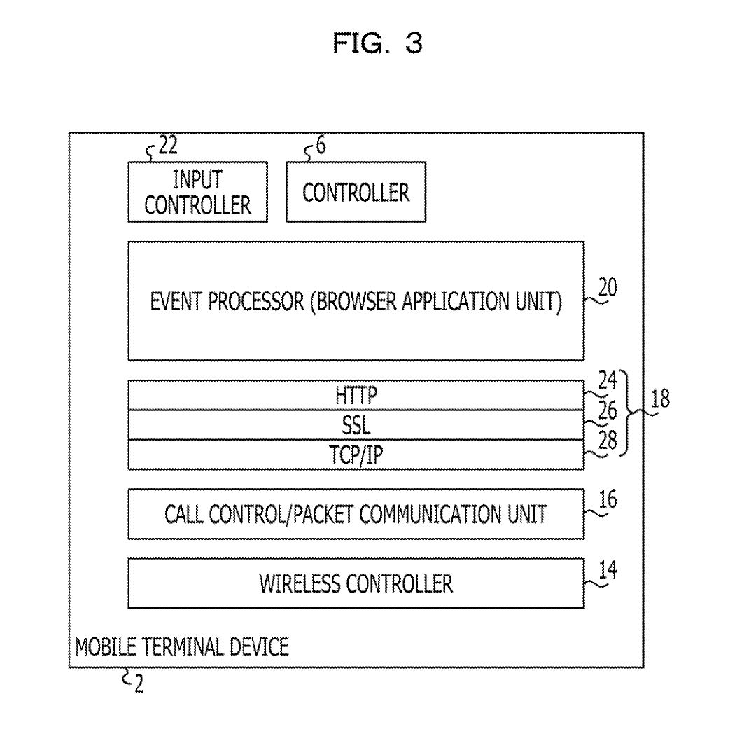

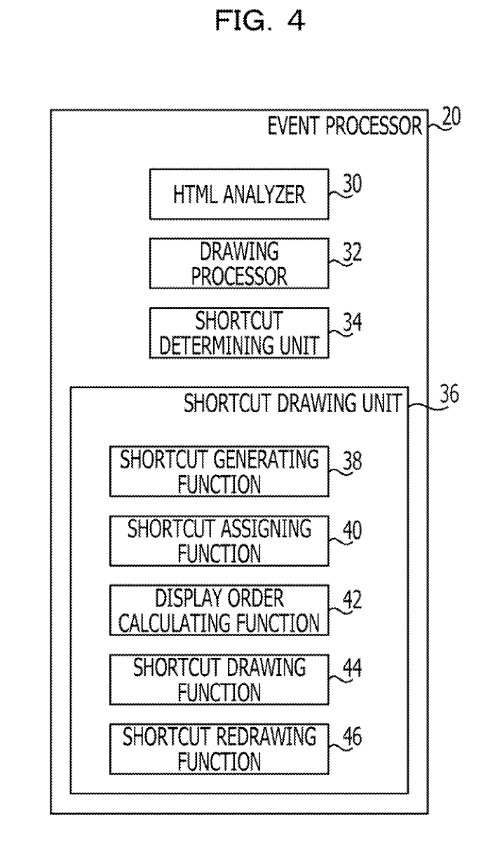

FIG. 3 illustrates an example of the mobile terminal device, while FIG. 4 illustrates an example of an event processor. In FIG. 3, parts that are the same as the parts illustrated in FIG. 1 are indicated by the same reference numerals.

The mobile terminal device 2 is the example of the mobile terminal device disclosed herein and the example of the recording medium disclosed herein, as described above. The mobile terminal device 2 has a communication function, an HTML processing function, a shortcut drawing function and the like.

A software configuration of the mobile terminal device 2 is described with reference to FIG. 3. The mobile terminal device 2 includes a wireless controller 14, a call control/packet communication unit 16, a communication protocol unit 18, an event processor 20, an input controller 22 and the controller 6 as illustrated in FIG. 3.

The wireless controller 14 wirelessly communicates with a communication device such as another mobile terminal device through a base station. The call control/packet communication unit 16 performs control of a call between the mobile terminal device 2 and a connection destination and performs packet communication.

The communication protocol unit 18 is means for establishing a communication protocol. The communication protocol unit 18 includes Hyper Text Transfer Protocol (HTTP) 24, Secure Sockets Layer (SSL) 26 and Transmission Control Protocol/Internet Protocol (TCP/IP) 28. HTTP 24 is a protocol that is used to establish communication between a browser and a server. SSL 26 is a security function that is provided between HTTP 24 and TCP/IP 28. TCP/IP 28 is a protocol that is used to generate a TCP packet and an IP packet having an IP address added thereto.

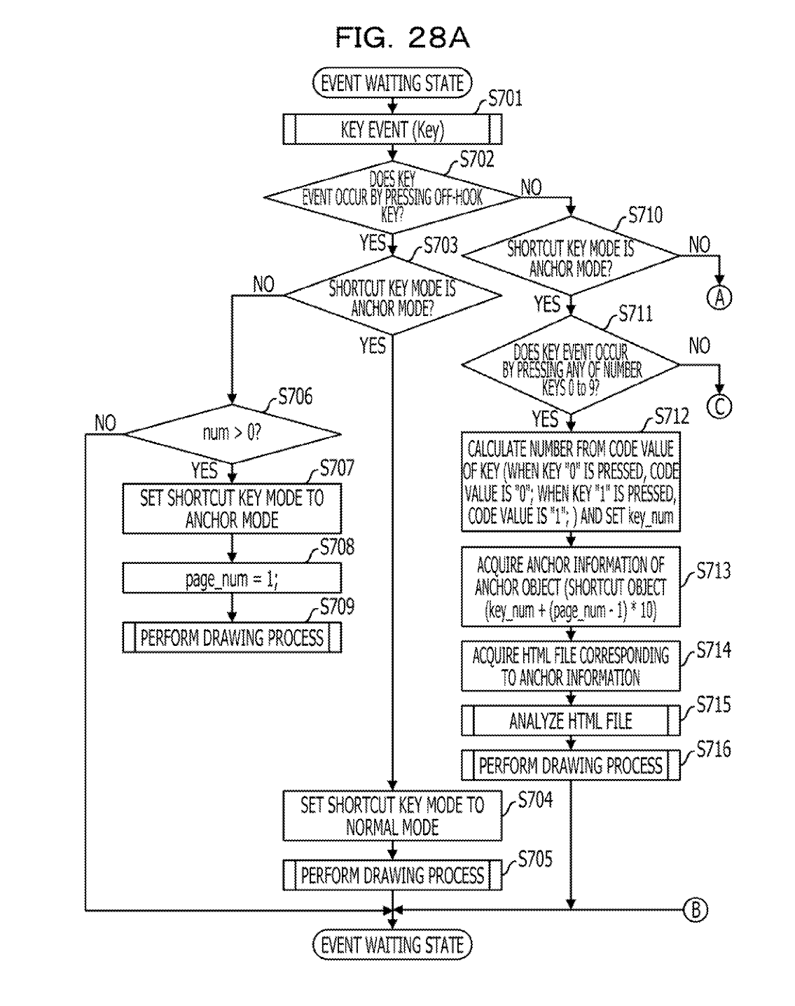

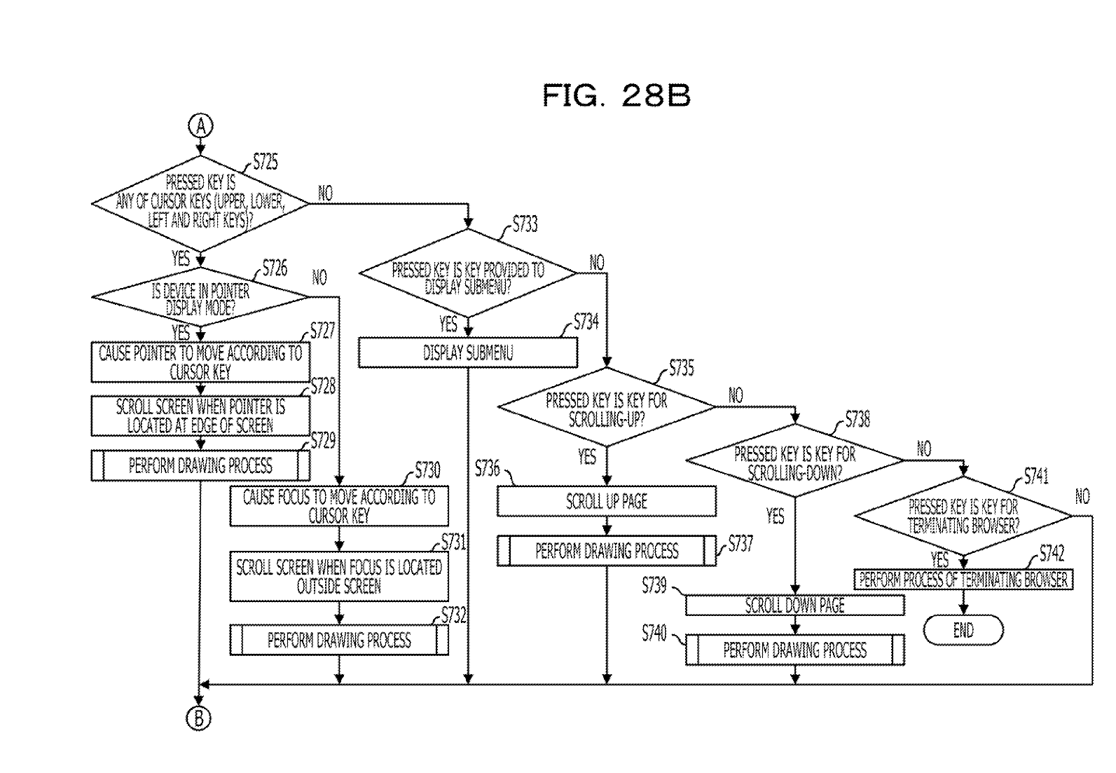

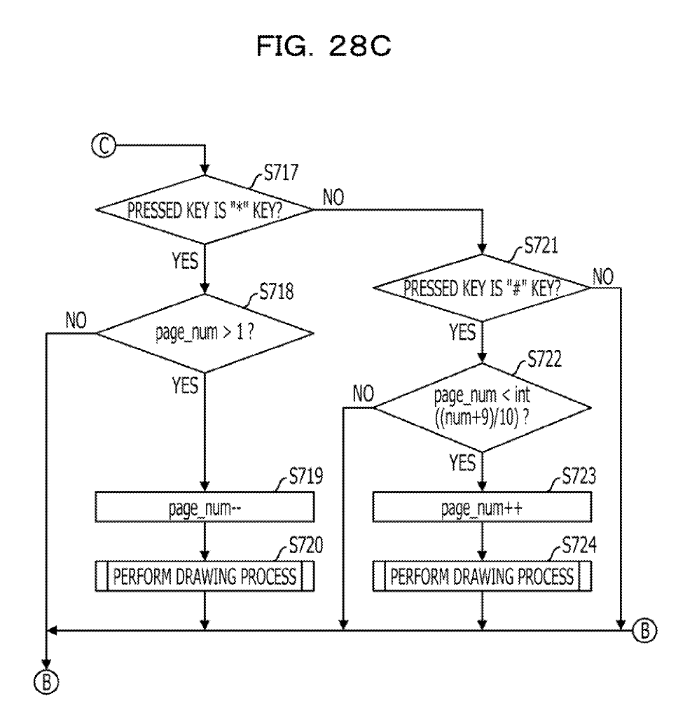

The event processor 20 executes a function of the controller 6 (illustrated in FIG. 1) and executes processes (for example, a process illustrated in FIGS. 28A to 28C) (including a drawing process) on the basis of an event such as a key event.

The input controller 22 processes an input event such as a key input. The controller 6 executes the process of acquiring data, the process of specifying an anchor, the process of editing data to be displayed and the process of displaying the data (to be displayed). Then, the controller 6 causes, on the basis of an output from the event processor 20, the display unit 4 to display the anchors 10 and the shortcuts 12.

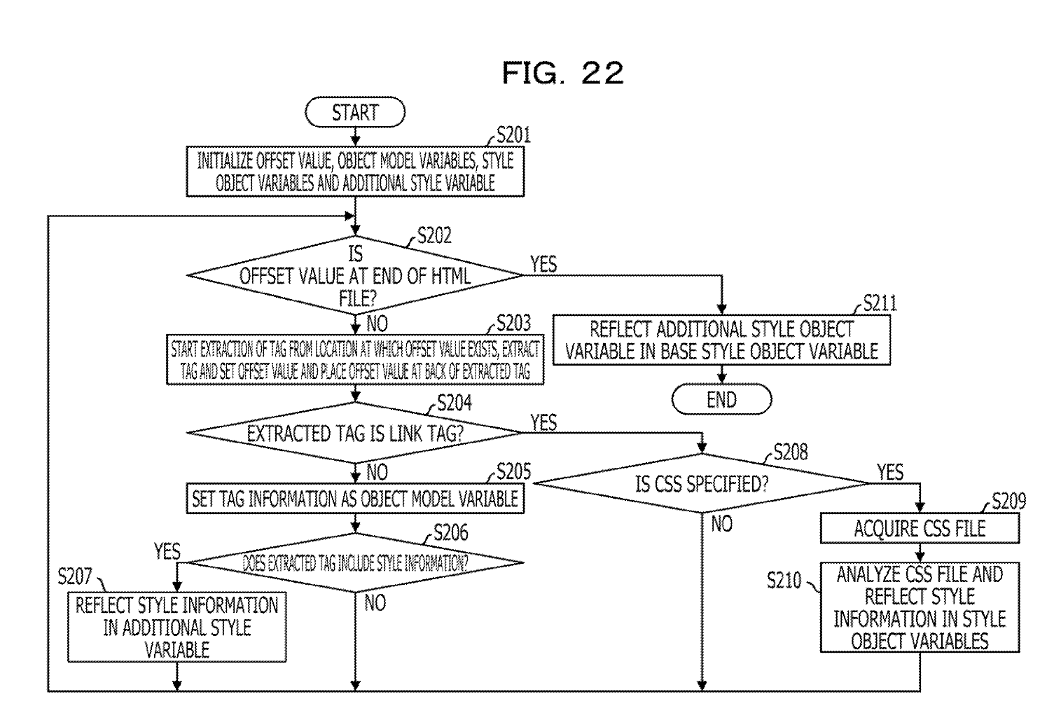

As illustrated in FIG. 4, the event processor 20 includes an HTML analyzer 30, a drawing processor 32, a shortcut determining unit 34 and a shortcut drawing unit 36. The HTML analyzer 30 executes an HTML analysis process (refer to, for example, FIG. 22). The drawing processor 32 draws a HTML content (and the like) on the screen 8. The shortcut determining unit 34 executes a process of determining a generated shortcut and the position of the shortcut to be displayed.

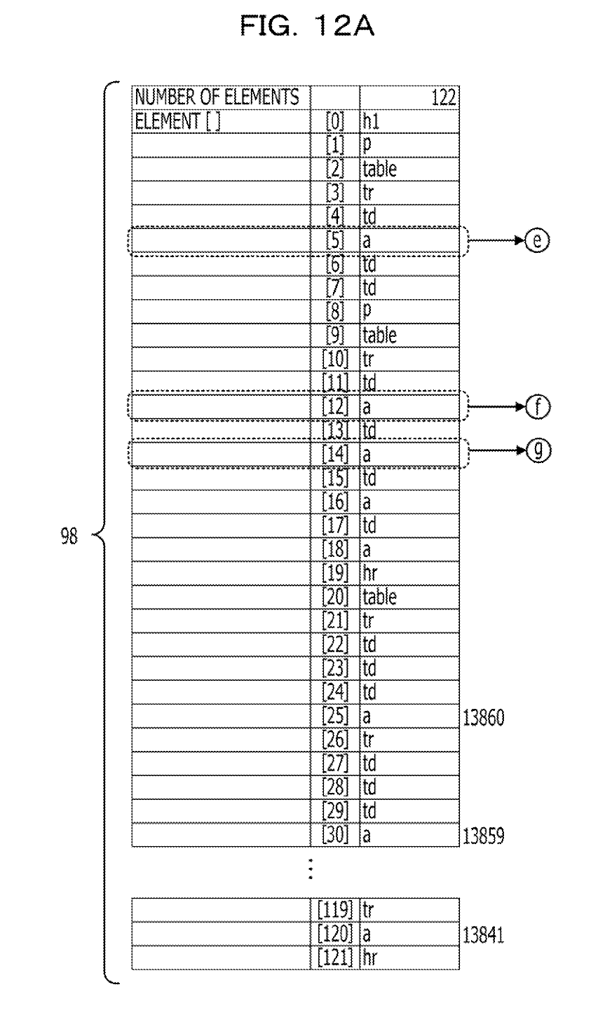

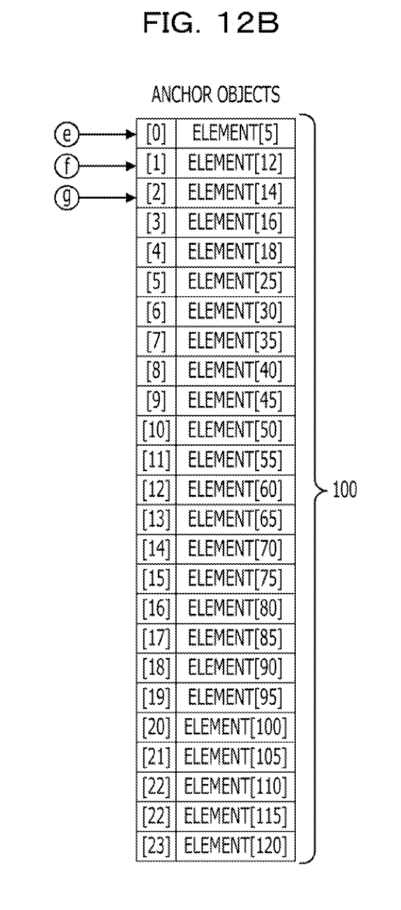

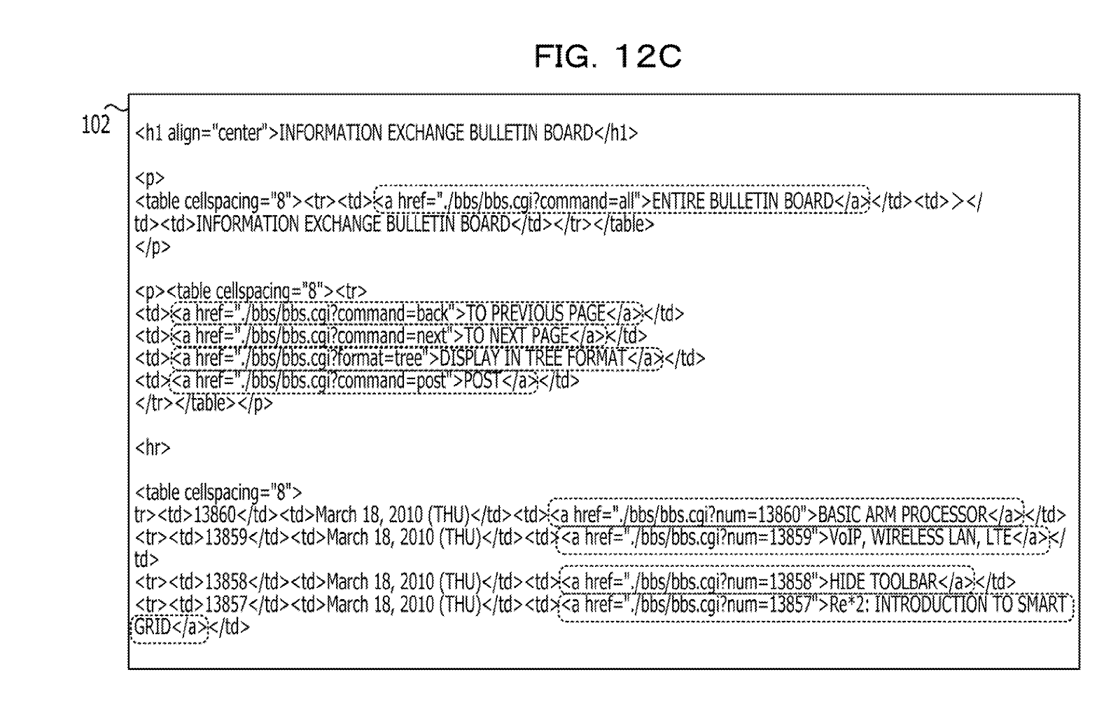

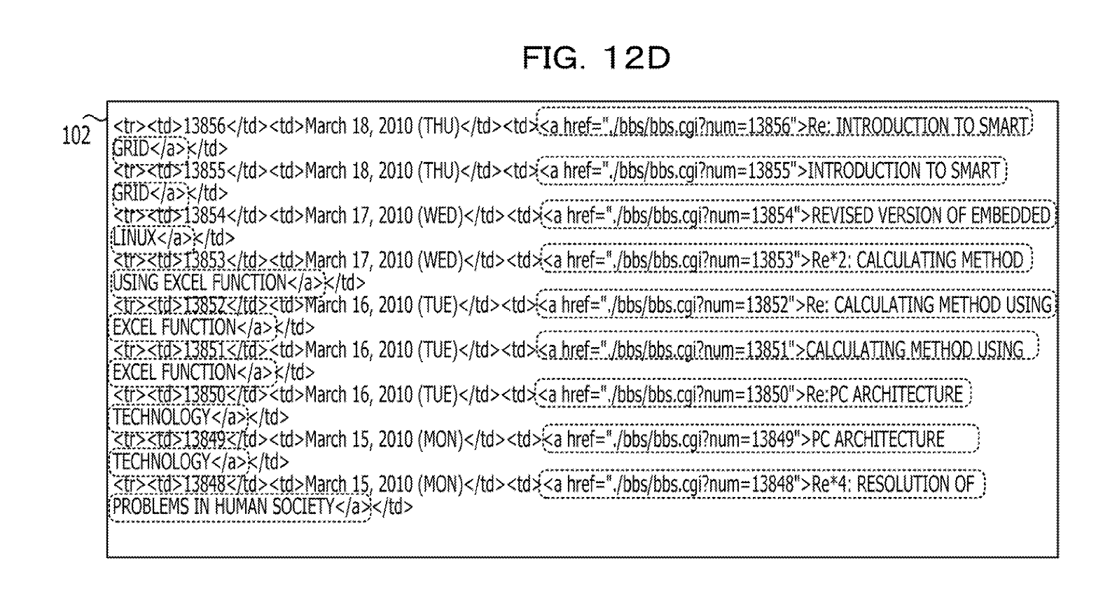

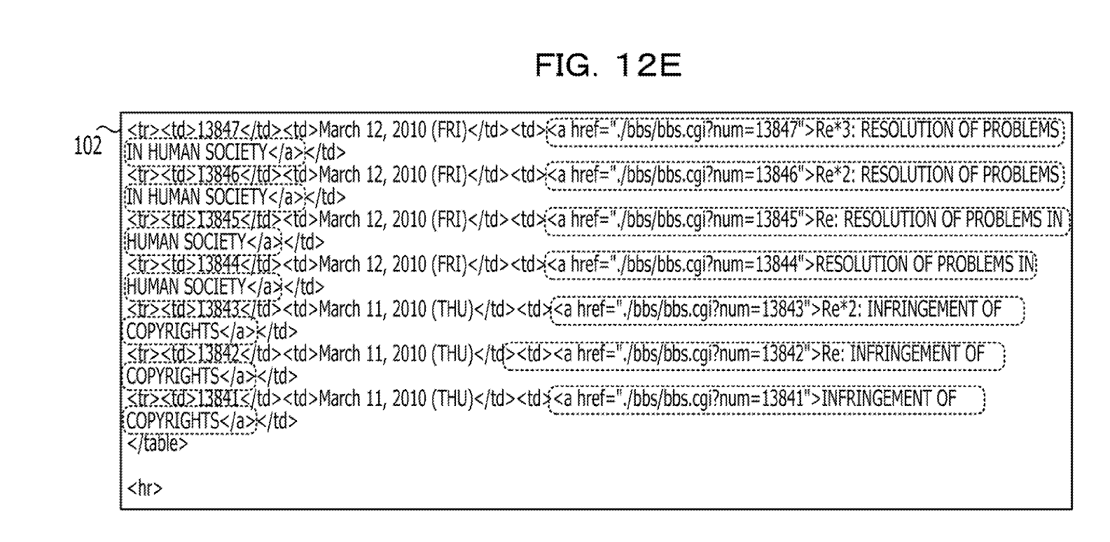

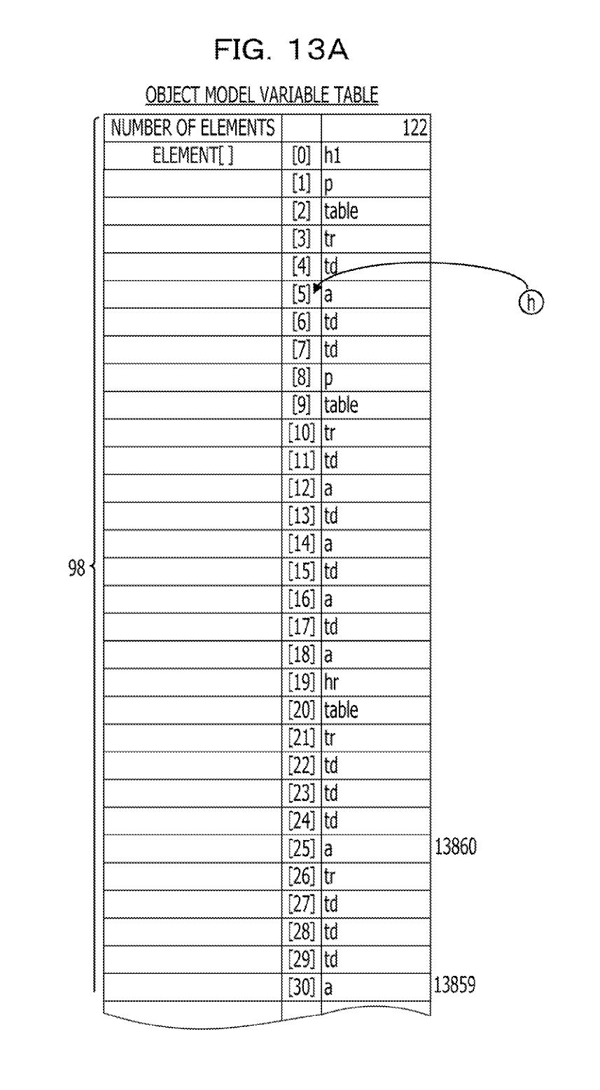

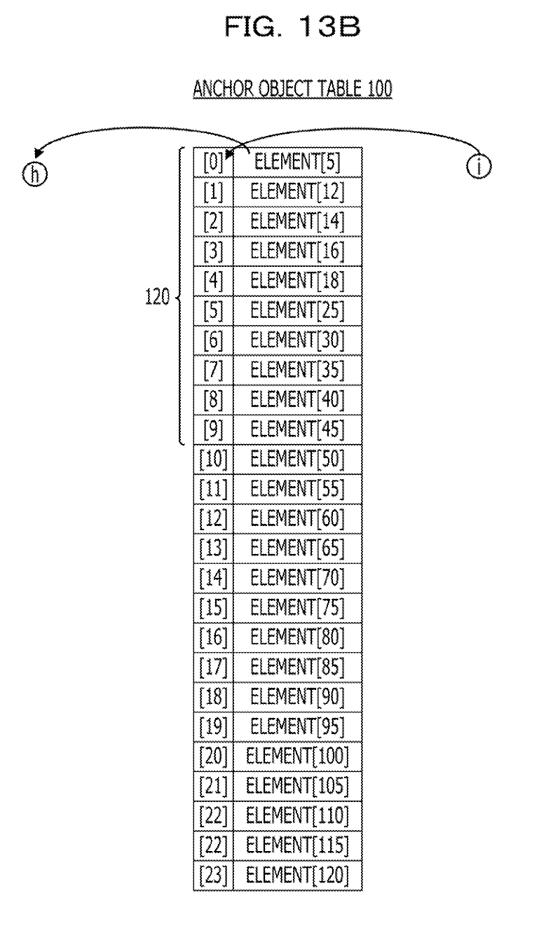

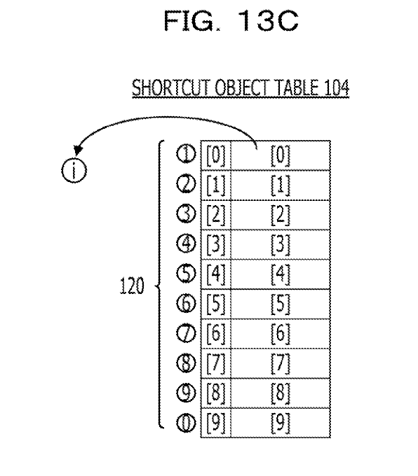

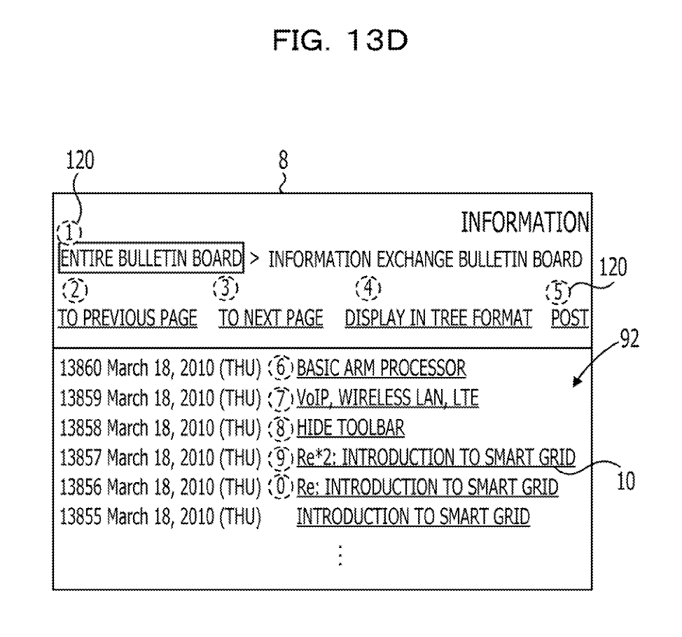

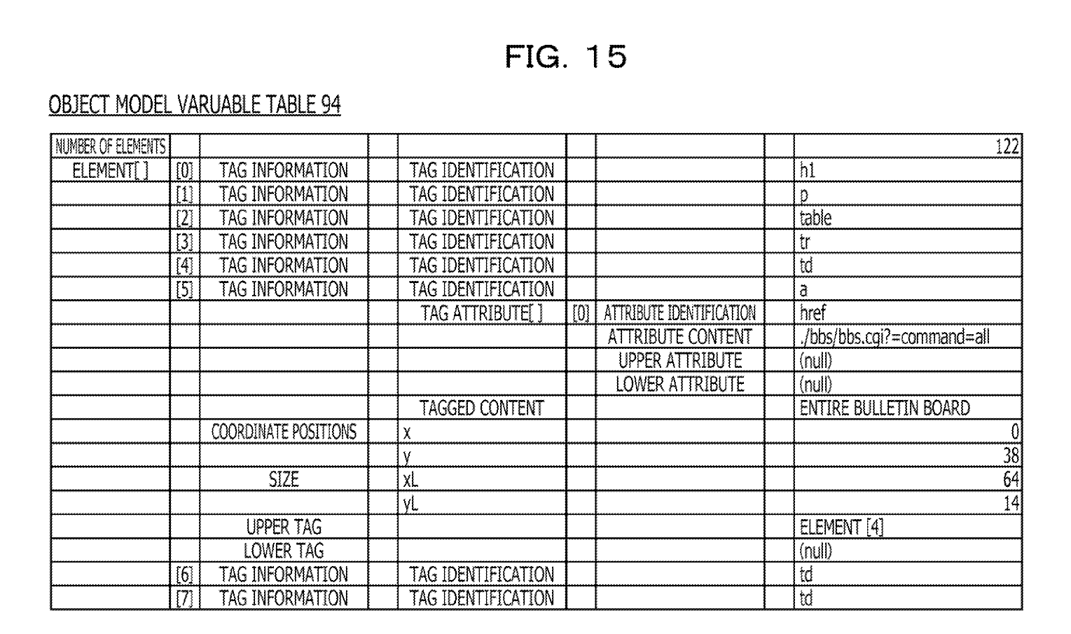

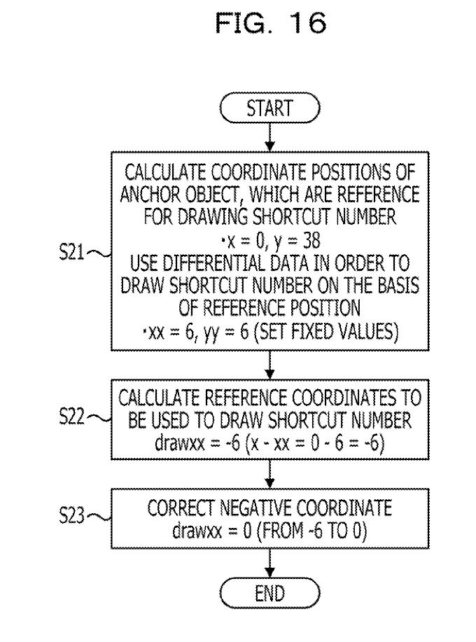

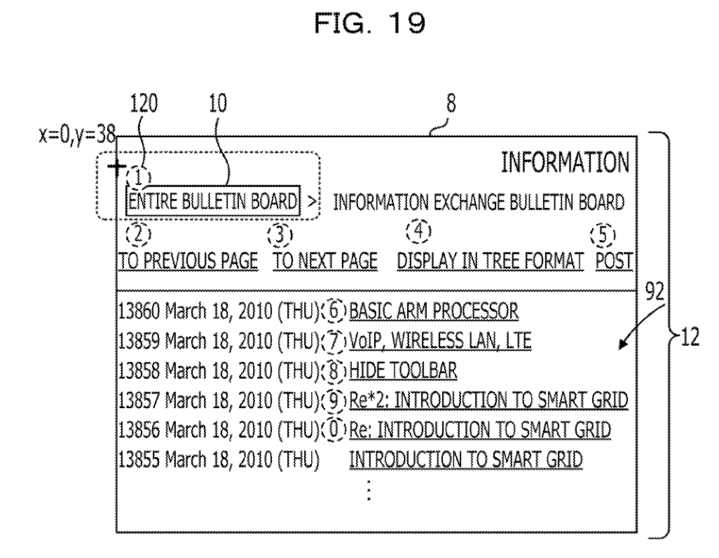

The shortcut drawing unit 36 executes a shortcut generating function 38 (refer to, for example, FIGS. 12A to 12E, 16 and 18), a shortcut assigning function 40 (refer to, for example, FIGS. 12A to 13D), a display order calculating function 42 (refer to, for example, FIGS. 15 and 16), a shortcut drawing function 44 (refer to, for example, FIG. 16) and a shortcut redrawing function 46 (refer to, for example, FIG. 19). After the drawing processor 32 draws an HTML content or the like, the shortcut drawing function 44 and the shortcut redrawing function 46 draws the shortcuts 12 that are assigned to the anchors 10. The process (function) of drawing the shortcuts 12 is a process of embedding data on the shortcuts 12 in an HTML content and displaying the shortcuts 12.

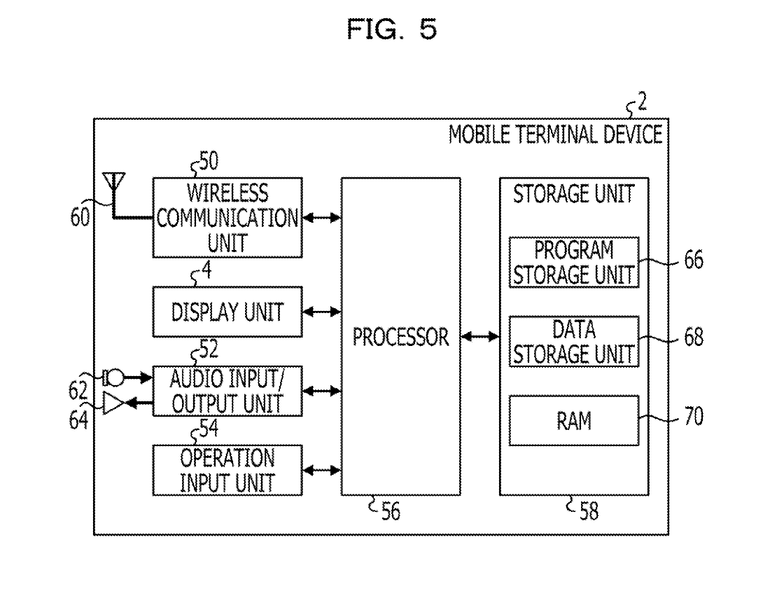

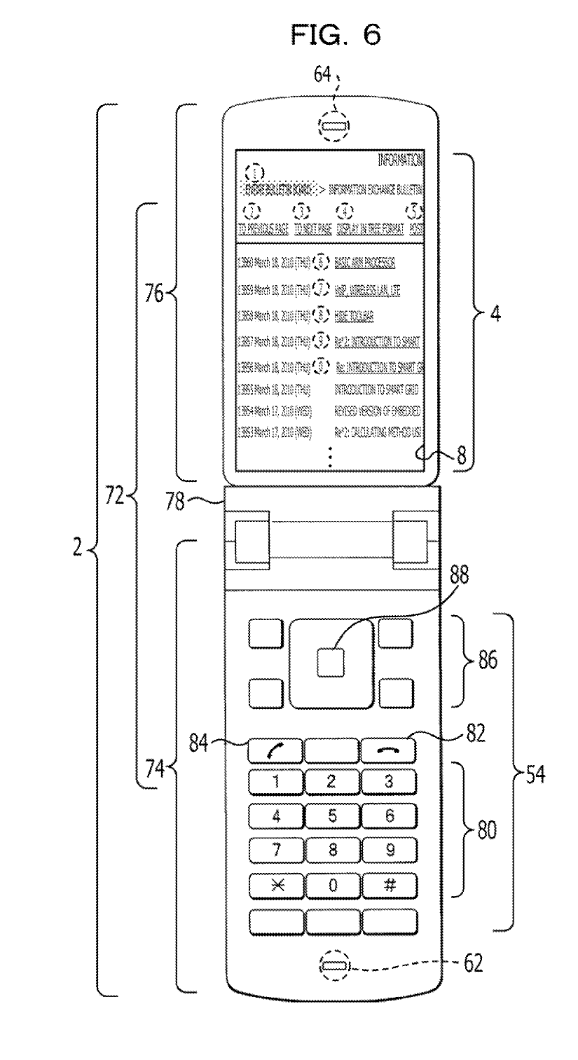

FIG. 5 illustrates an example of hardware of the mobile terminal device, while FIG. 6 illustrates an example of the configuration of the mobile terminal device. In FIGS. 5 and 6, parts that are the same as the parts illustrated in FIG. 1 are indicated by the same reference numerals.

The hardware of the mobile terminal device 2 is an example of the mobile terminal device disclosed herein and achieves the aforementioned processes and functions. The mobile terminal device 2 includes a wireless communication unit 50, the display unit 4, an audio input/output unit 52, an operation input unit 54, a processor 56 and a storage unit 58. The wireless communication unit 50 includes an antenna 60 and transmits and receives data using a radio wave under control of the processor 56. The wireless communication unit 50 can receive content from a server through the communication.

The display unit 4 displays anchors 10 of the content and shortcuts 12 on the screen 8 under control of the processor 56. The display unit 4 may be constituted by a liquid crystal display (LCD).

The audio input/output unit 52 is controlled by the processor 56, converts an input signal into an electric signal, and reproduces audio data from an output signal. The audio input/output unit 52 converts a signal received from a microphone 62 into an electric signal. The output signal is converted into audio data by a receiver 64.

The operation input unit 54 causes various operational inputs from the numeric keypad, cursor keys and the like to be input to the processor 56.

The processor 56 is an example of the aforementioned controller 6 (illustrated in FIG. 1). The processor 56 constitutes means for executing the processes (illustrated in FIG. 2) of acquiring data, specifying an anchor, editing data to be displayed and displaying the data (to be displayed). The processor 56 is constituted by a central processing unit (CPU) or a micro processor unit (MPU), for example. The processor 56 executes processes corresponding to functional units by executing various programs (such as an operating system (OS) and an application program) stored in the storage unit 58. The processor 56 is means for controlling each of the functional units and constitutes calculating means. The programs can be distributed to the mobile terminal device 2 through a communication network such as the Internet. In addition, the programs are stored in a recording medium (such as a memory, a hard disk or another recording medium from which data can be read by the mobile terminal device 2) included in the mobile terminal device 2. The programs can be executed by the mobile terminal device 2 when the mobile terminal device 2 reads the programs from the recording medium.

The storage unit 58 is means for storing the programs and various types of data. The storage unit 58 includes a recording medium. The storage unit 58 has a program storage unit 66, a data storage unit 68 and a random-access memory (RAM) 70. The aforementioned OS and application program are stored in the program storage unit 66. The information selection support program disclosed herein is stored in the program storage unit 66. Acquired contents described in HTML and XHTML, the aforementioned shortcuts and the like are stored in the data storage unit 68. The RAM 70 temporarily stores data that is being calculated and a calculation result. The RAM 70 is used as a work area for an executed program.

As illustrated in FIG. 6, the mobile terminal device 2 has a housing 72. The housing 72 includes an operating section housing 74 and a display section housing 76. The mobile terminal device 2 can be opened and closed by a hinge 78. The operation input unit 54 and the microphone 62 are installed in the operating section housing 74. A numeric keypad 80, an on-hook key 82, an off-hook key 84, cursor keys 86 and an enter key 88 are included in the operation input unit 54. The display unit 4 and the receiver 64 are installed in the display section housing 76. The aforementioned screen 8 is displayed on the display unit 4.

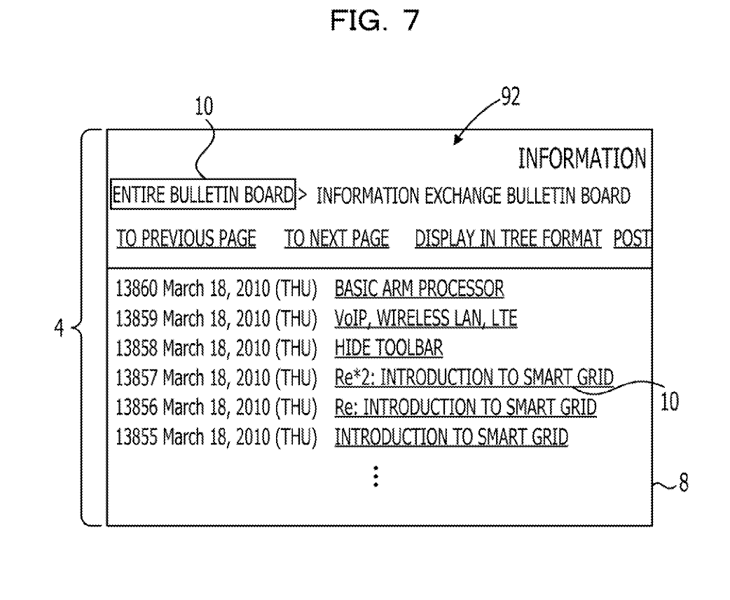

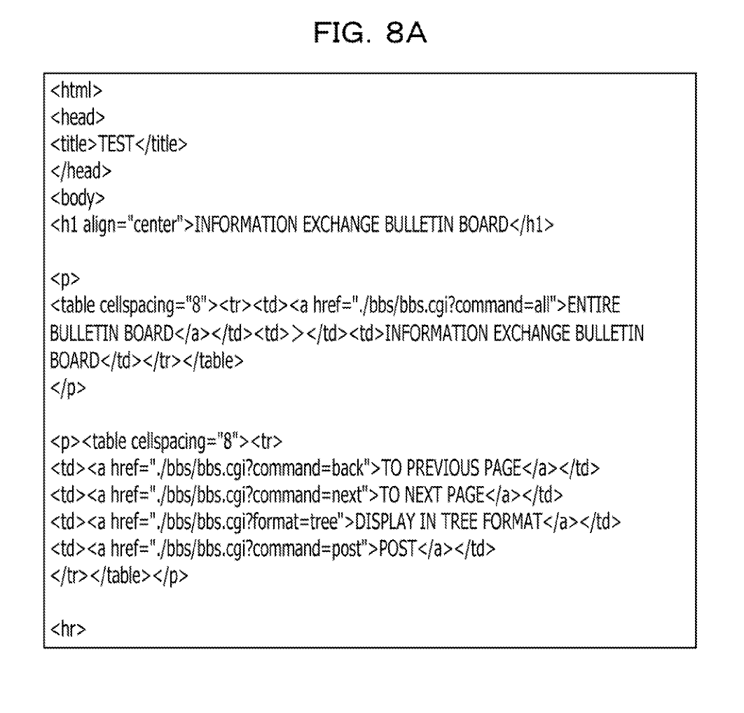

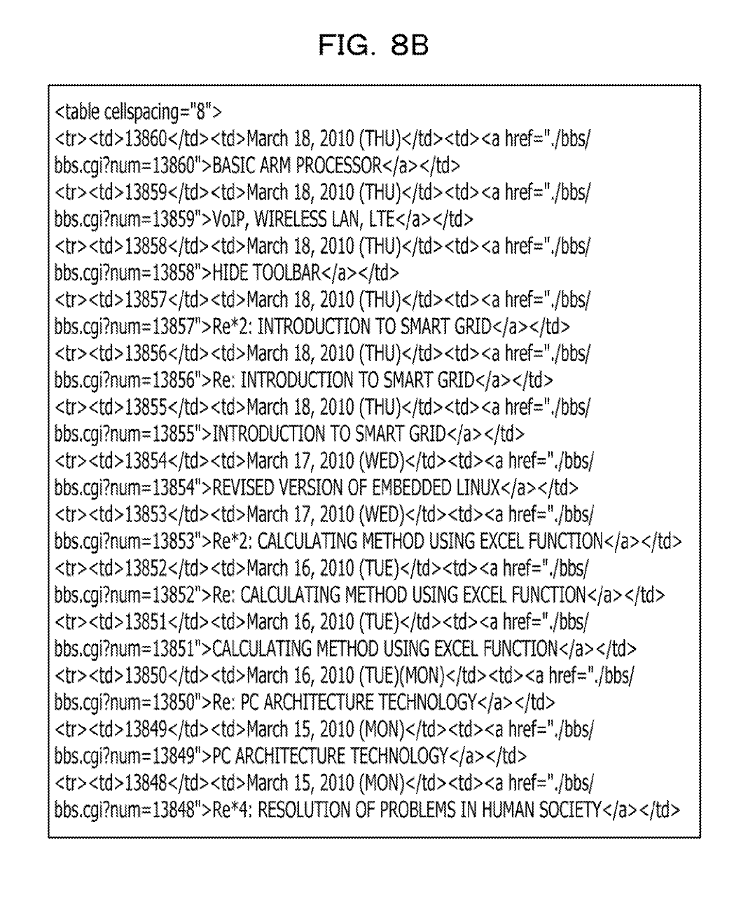

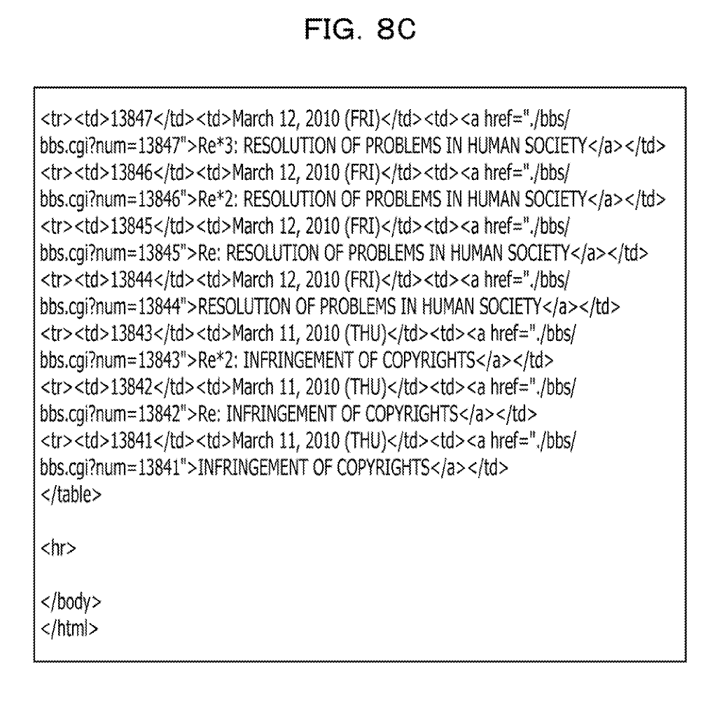

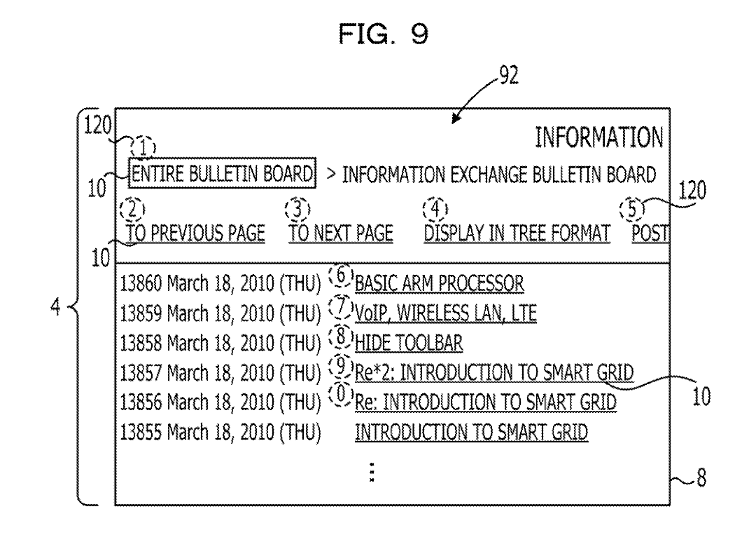

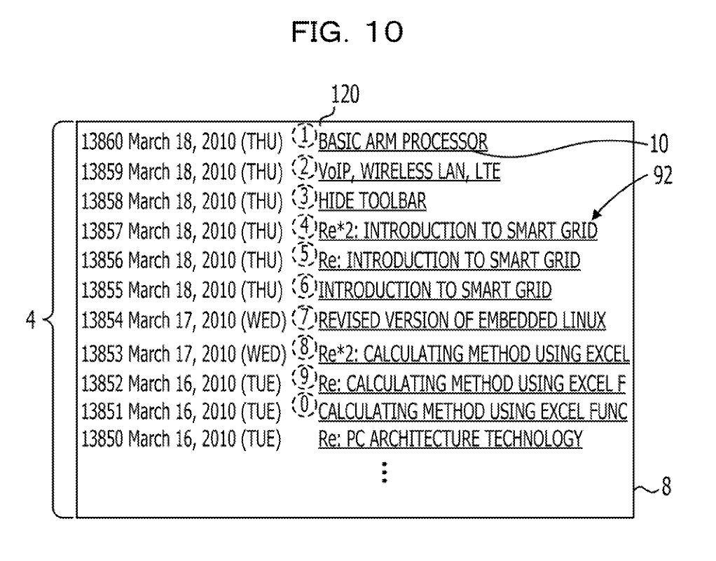

FIG. 7 illustrates an example of a displayed content. FIG. 8 illustrates details that are described in HTML and represent the example of the displayed content. FIG. 9 illustrates the displayed content to which shortcuts are added. FIG. 10 illustrates an example of the displayed content to which shortcuts are added after scrolling of the screen. In FIGS. 7, 8, 9 and 10, parts that are the same as the parts illustrated in FIG. 6 are indicated by the same reference numerals. The displayed content in the FIG. 9 is an enlarged one illustrated in the FIG. 6.

When the mobile terminal device 2 establishes communication and acquires an HTML file from a specified URL, a content 92 is displayed on the screen 8 of the display unit 4 so that a plurality of anchors 10 are displayed on the screen 8 of the display unit 4 as illustrated in FIG. 7. As described above, the anchors 10 are underlined or surrounded by frames in order to distinguish between the anchors 10 and other character information. In this example of the displayed content including the anchors 10, the content is described in HTML as illustrated in FIGS. 8A to 8C.

When the shortcuts are generated for the displayed content, shortcut numbers 120 are displayed as the shortcuts 12 in ascending order from an anchor located on the uppermost and leftmost side of the screen 8 as illustrated in FIG. 9. The shortcut numbers 120 are numbers that correspond to numbers of the numeric keypad 80 of the operation input unit 54. The shortcut numbers 120 are Arabic numerals surrounded by circles. The shortcut numbers 120 are displayed using a bold text, compared to characters representing the content. The shortcut numbers 120 are assigned to the anchors 10 in ascending order from the anchor located on the uppermost and leftmost side of the screen 8. The shortcut numbers 120 are specified by the key numbers of the numeric keypad. In the present embodiment, the anchors 10 are underlined and displayed using blue characters, and the shortcut numbers 120 are surrounded by the circles and displayed using red characters so that the shortcut numbers 120 overlap the anchors 10, respectively. In other words, the shortcut numbers 120 are overlaid and displayed.

When the screen 8 on which the shortcut numbers 120 and the content 92 are displayed is scrolled down, details of the displayed content are changed as illustrated in FIG. 10. Even when the details of the displayed content are changed, the shortcut numbers 120 are assigned to anchors 10 displayed on the screen 8. Specifically, the shortcut numbers 120 are displayed in ascending order from an anchor located on the uppermost side of the screen 8 to an anchor located on the lower side of the screen 8, regardless of details of the anchors 10 displayed on the screen 8. In the present embodiment, the shortcut numbers 120 are assigned to ten anchors 10 and displayed in ascending order.

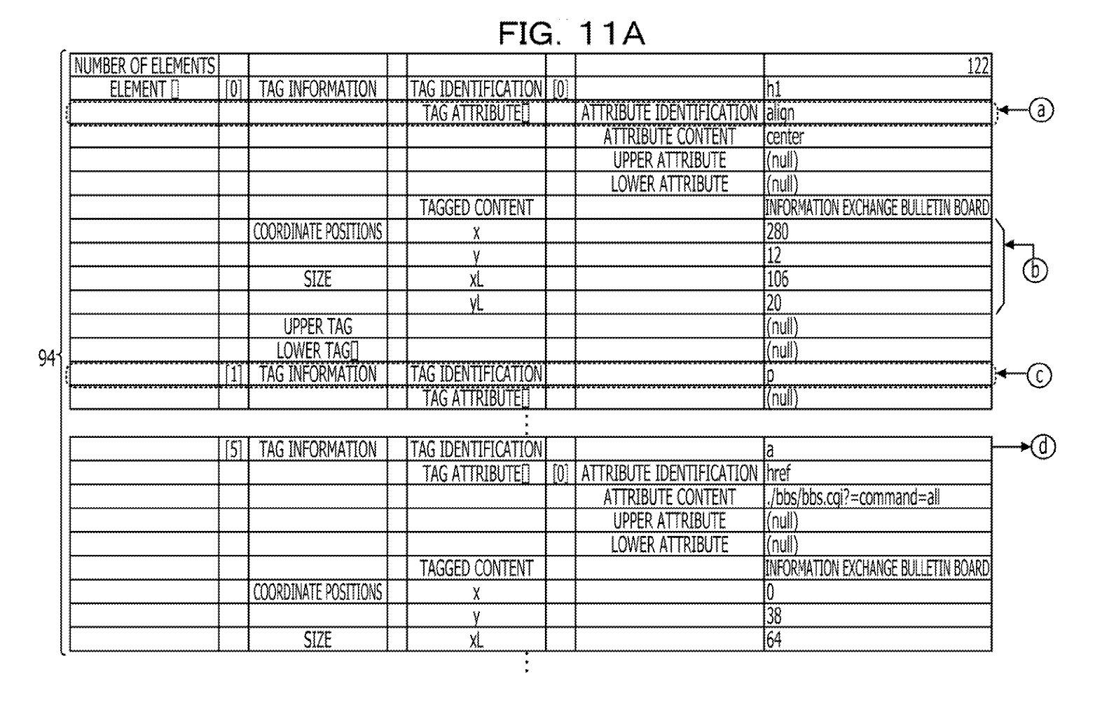

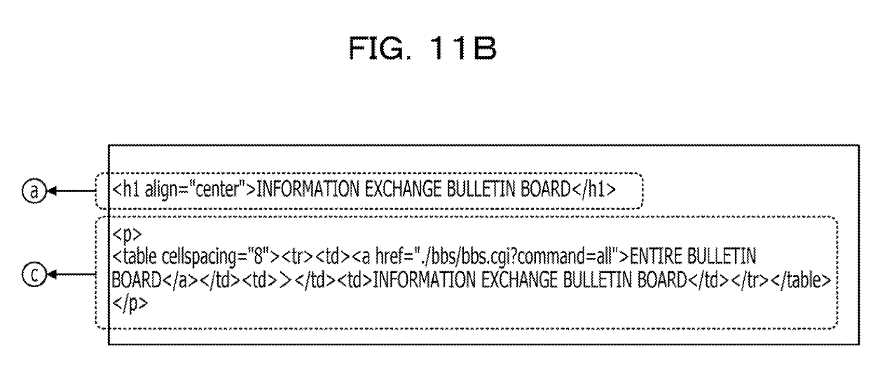

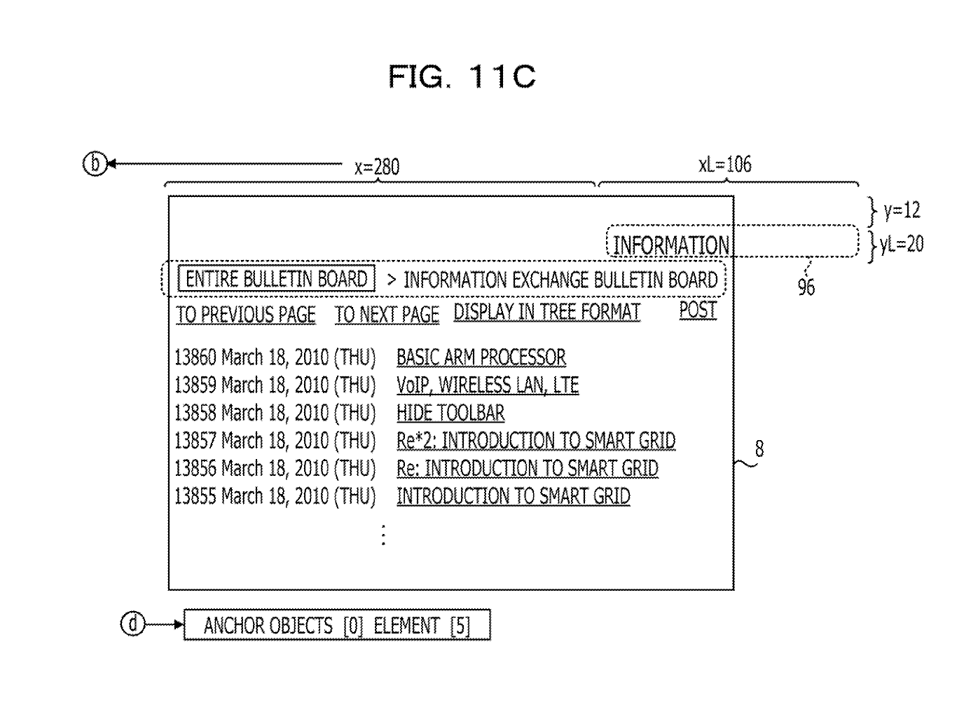

FIGS. 11A to 12E illustrate an example of a displayed content.

As illustrated in FIG. 11A, element information, tag information, the coordinate positions of contents to be drawn, the sizes of the contents to be drawn and the like are described in an object model variable table 94. FIG. 11B illustrates a part of an HTML file that represents the example of the displayed content. The part of the HTML file is a part relating to drawing and is treated as an object model variable. The part of the HTML file is extracted from the object model variable table 94. A symbol B1 that is indicated in a table illustrated in FIG. 11B corresponds to an element [0] that is indicated in the object model variable table 94. In addition, the symbol B1 corresponds to an “information exchange bulletin board” that is a title of the example of the displayed content (illustrated in FIG. 7). A symbol B2 that is indicated in the table illustrated in FIG. 11B corresponds to the “tag information and size” of an element [1] indicated in the object model variable table 94.

FIG. 11C illustrates the example of the displayed content. Coordinate positions x and y illustrated in FIG. 11C correspond to “coordinate positions” of a content (to be drawn) of the element [0] indicated in the object model variable table 94, while lengths xL and yL illustrated in FIG. 11C correspond to the “size” of the content (to be drawn) of the element [0] indicated in the object model variable table 94. The position x indicates an X coordinate position, while the position y indicates a Y coordinate position. The length xL is a length in X direction, while the length yL is a length in Y direction. In the example of the displayed content, a point that is located on the uppermost and leftmost side of the screen 8 is the point of origin. In the example of the display screen (illustrated in FIG. 11C), the coordinate positions x and y of a head of a displayed portion 96 that represents “Information . . . ” are 280 and 12, respectively. The lengths xL and yL of the displayed portion 96 are 106 and 20, respectively. The coordinate positions and size of the displayed portion 96 are already determined.

Tag information of an element [5] indicated in the object model variable table 94 corresponds to an anchor object. The coordinate positions and size of a tagged content (to be drawn) of the element [5] are referenced, and whereby it is determined whether or not the tagged content is displayed within the screen.

FIG. 12A illustrates an organization table 98 of elements indicated in the object model variable table 94. FIG. 12B illustrates an anchor object table 100. In the anchor object table 100, only a part relating to drawing is treated as an object model variable, and a tag identification is described. FIGS. 12C to 12E illustrate a content configuration table 102.

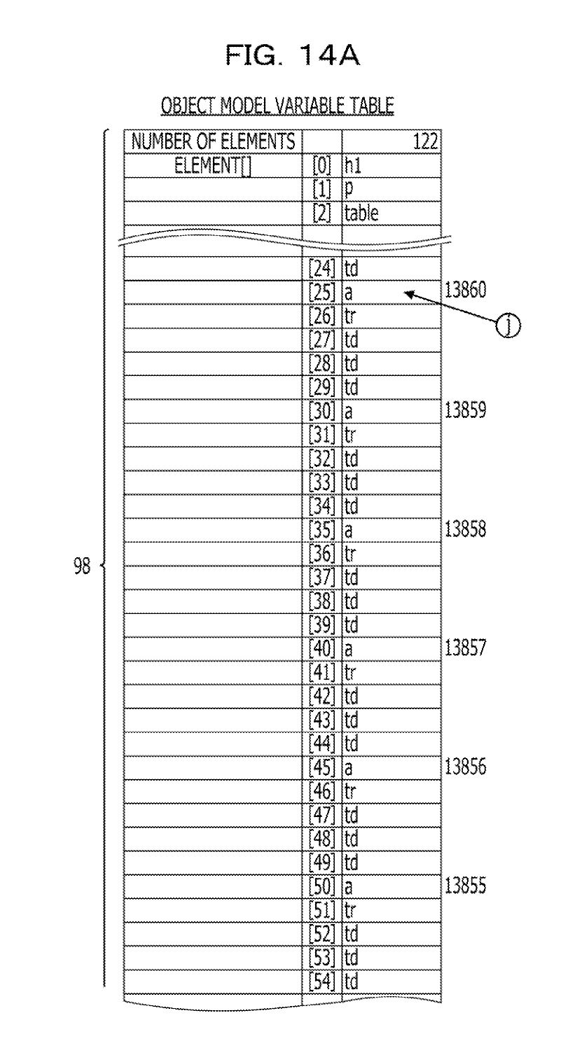

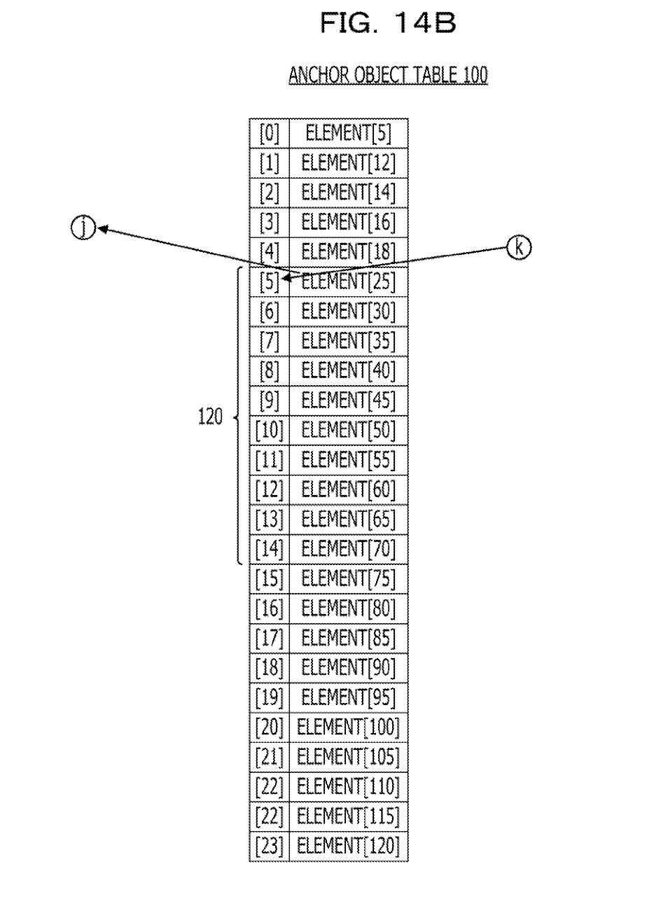

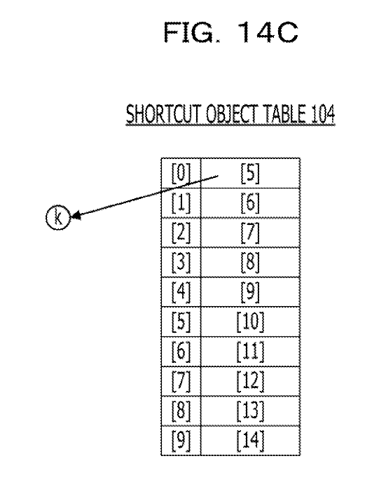

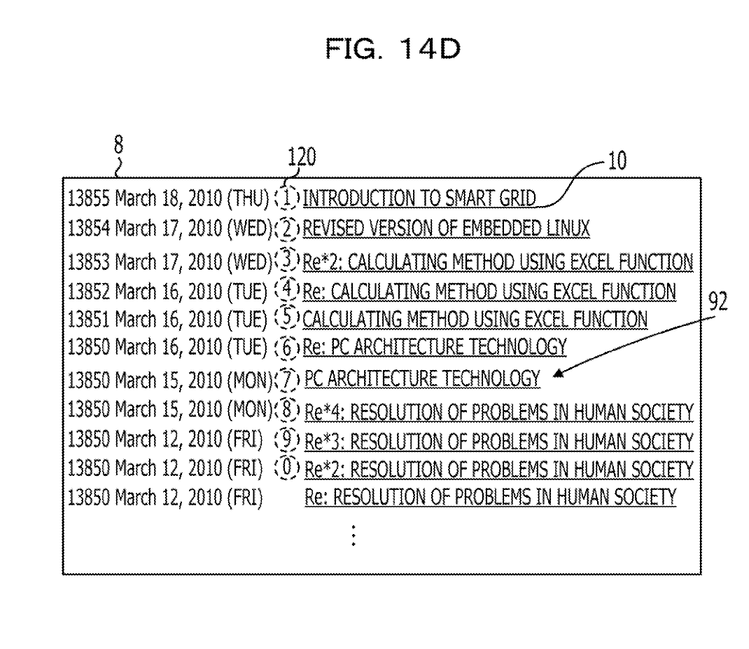

Next, scrolling of the screen and shifting of shortcuts are described with reference to FIGS. 13A to 14D. FIGS. 13A to 13D illustrate a displayed content and displayed shortcuts before scrolling of the screen, while FIG. 14A to 14D illustrate the displayed content and the displayed shortcuts after scrolling of the screen.

FIGS. 13A and 14A illustrate the organization table 98 of the elements indicated in the object model variable table 94. As illustrated in FIG. 13B, before scrolling of the screen, elements [5], [12], . . . , [45] are used, and anchor objects are set in a shortcut object table 104 (illustrated in FIG. 13C). The elements [5], [12], . . . , [45] correspond to ten shortcut numbers 120 to be displayed. The shortcut numbers 120 are generated on the basis of the use of the elements and the setting of the anchor objects. As illustrated in FIG. 13D, the shortcut numbers 120 are assigned to the anchors 10 in ascending order from an anchor located on the uppermost side of the screen 8 and are displayed on the screen 8.

Next, an example in which the screen 8 is scrolled so that an anchor 10 that corresponds to an item number 13855 illustrated in FIG. 13D is located on the uppermost side of the screen 8 is described. Thus, an anchor 10 that corresponds to an item number 13856 is not displayed on the screen 8.

In this case, the sixth element [25] and elements [30], . . . , [70] of the anchor object table 100 are used as illustrated in FIG. 14B, and anchor objects are set in the shortcut object table 104 (as illustrated in FIG. 14C). The shortcut numbers 120 are generated on the basis of the use of the elements and the setting of the anchor objects. Then, the shortcut numbers 120 are assigned to anchors 10 in ascending order from an anchor that is located on the uppermost side of the screen 8 and indicates “Introduction to Smart Grid” and are displayed on the screen 8 as illustrated in FIG. 14D. In other words, even when the anchors 10 are changed by scrolling, a predetermined number of the shortcut numbers 120 are generated and displayed in ascending order from an anchor 10 located on the uppermost side of the screen 8.

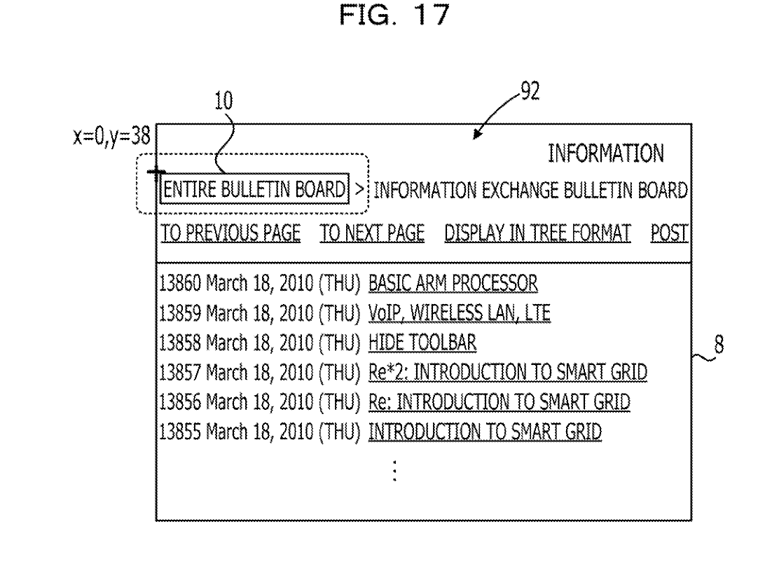

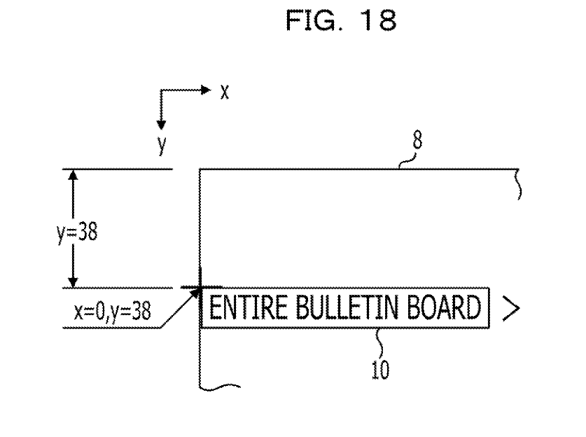

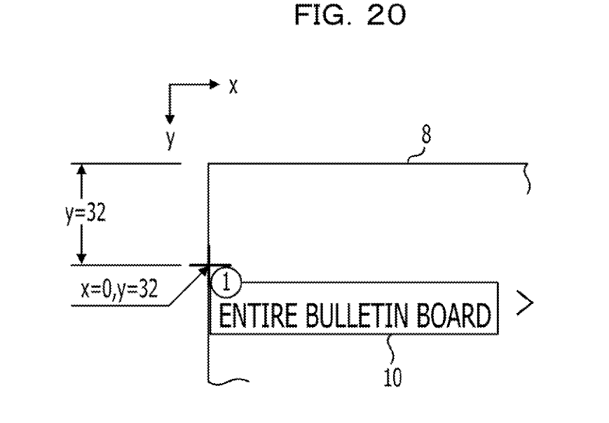

Next, the display of the shortcut numbers 120 and the positions of the displayed shortcut numbers 120 are described below with reference to FIGS. 15, 16, 17, 18, 19 and 20. FIG. 15 illustrates the object model variable table. FIG. 16 illustrates an example of procedures of a process that is performed on a shortcut to be displayed. FIGS. 17 and 18 illustrate the position of the displayed shortcut. FIGS. 19 and 20 illustrate the corrected position of the shortcut.

As illustrated in FIG. 15, the coordinate positions x and y are referenced from tag information of the element [5] of the object model variable table 94 in order to display a shortcut number 120.

In this case, the process procedures illustrated in FIG. 16 are performed in order to calculate the coordinate positions. The process procedures illustrated in FIG. 16 are an example of the information selection support program of the mobile terminal device disclosed herein. Also, the process procedures illustrated in FIG. 16 are an example of an information selection supporting method disclosed herein. As illustrated in FIG. 16, the process procedures include a process (step S21) of calculating coordinate positions, a process (step S22) of calculating reference coordinates and a process (step S23) of correcting a coordinate.

In the process (step S21) of calculating coordinate positions, the coordinate positions of an anchor object, which are a reference for drawing the shortcut number 120, are determined. In this case, coordinate positions (x=0, y=38) are used as an example. Differential data (xx=6, yy=6) that is used to draw the shortcut number at the reference coordinate positions is used. The differential data is set to fixed values.

The process (step S22) of calculating reference coordinates is performed in order to draw the shortcut number 120. A reference coordinate drawxx (=−6 (x−xx)) is first calculated and is 0−6=−6.

In the process (step S23) of correcting a coordinate, a negative coordinate is calculated. Thus, the reference coordinate drawxx is set to 0 (from −6).

As a result, the coordinate positions of the shortcut number 120 to be displayed are determined as x=0 and y=38, as illustrated in FIGS. 17 and 18. Then, the corrected coordinate positions are x=0 and y=32 as illustrated in FIGS. 19 and 20.

Next, processes from a process of acquiring an HTML file to a process of displaying a shortcut number for an anchor are described.

Acquisition and Analysis of HTML File and Drawing Process

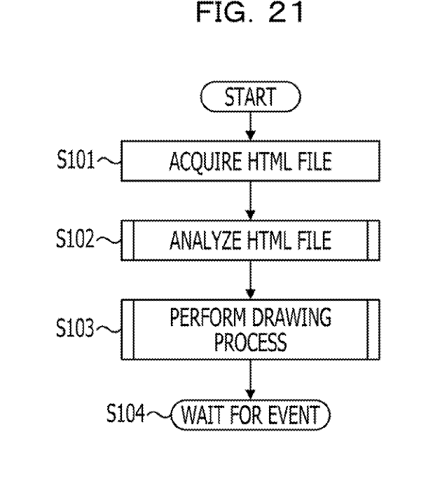

FIG. 21 illustrates an example of procedures of an acquisition of an HTML file, an analysis of the HTML file and a drawing process.

The process procedures illustrated in FIG. 21 are an example of the information selection supporting method disclosed herein. The process procedures include a process (step S101) of acquiring an HTML file, a process (step S102) of analyzing the HTML file and a drawing process (step S103). After the drawing process (in step S103), the mobile terminal device becomes an event waiting state in the process illustrated in FIG. 21 (in step S104).

In the HTML acquisition process (step S101), an HTML file of a specified URL is acquired when the process starts.

In the HTML analysis process (step S102), the acquired HTML file is analyzed. In the HTML file analysis process, the HTML file is analyzed, and various types of tag information are analyzed and held as object model variables. In addition, anchor objects that are among the object model variables are used to draw shortcut numbers in the drawing process (step S103).

In the drawing process (S103), an HTML content is drawn on the basis of the object model variables and style object variables. In addition, shortcuts are assigned to anchors, and shortcut numbers are drawn in the drawing process (S103).

HTML Analysis Process

FIG. 22 illustrates an example of procedures of the HTML analysis process.

In the HTML analysis process, the various types of tag information included in a range from head to end of the HTML file are extracted and held as object model variables. When a link tag exists in the HTML file and a cascading style sheets (CSS) file is set, the CSS file is acquired and details of the CSS file are reflected in the style object variables. When a style is specified in the tag information, the style is reflected in an additional style variable. Details of the additional style variable are reflected in the style object variables before the process illustrated in FIG. 22 is terminated. In this case, the style is used to draw data corresponding to a tag and indicates the color, size and position of the data corresponding to the tag. When a text is specified in the tag information, the text indicates the type of a font, the size of the font, the color of the font, alignment of the font or the like. In the drawing process, details of data to be drawn are determined on the basis of the object model variables and the style object variables.

In the HTML analysis process, an offset value, the object model variables, the style object variables and the additional style variable are initialized (in step S201) as illustrated in FIG. 22. After the initialization, it is determined whether or not the offset value is at the end of the HTML file (in step S202).

When the offset value is not at the end of the HTML file (No in step S202), an extraction of a tag starts from a location at which the offset value exists, and the tag is extracted. Then, the offset value is set and located at the back of the extracted tag (in step S203).

It is determined whether or not the extracted tag is a link tag (in step S204). When the extracted tag is not the link tag (No in step S204), the tag information is set as an object model variable (in step S205).

It is determined whether or not the extracted tag includes style information (in step S206). When the extracted tag includes the style information (Yes in step S206), the style information is reflected in the additional style variable (in step S207) and the process returns to step S202. On the other hand, when the extracted tag does not include the style information (No in step S206), the process returns to step S202.

When the extracted tag is the link tag (Yes in step S204), it is determined whether or not CSS is specified (in step S208). When the CSS is specified (Yes in step S208), a CSS file is acquired (in step S209). Then, the CSS file is analyzed, and style information is reflected in the style object variable (in step S210) and the process returns to step S202.

When the CSS is not specified (No in step S208), the process returns to step S202.

When the offset value is at the end of the HTML file (Yes in step S202), the additional style object variable is reflected in a base style object variable (in step S211), and the process is terminated.

In the process procedures illustrated in FIG. 22, the object model variables indicate the number of elements and an array of the elements. The elements each include tag information, coordinate positions, a size, an upper tag and a lower tag. The upper tag is an element number that indicates an upper element. The lower tag is an element number that indicates a lower element. The tag information includes the identification of a tag, an attribute of the tag and a tagged content. The tag attribute includes the identification of the attribute, an attribute content, an upper attribute and a lower attribute. The coordinate positions are determined by a position in X direction and a position in Y direction. The size is determined by the lengths xL and yL.

Drawing Process

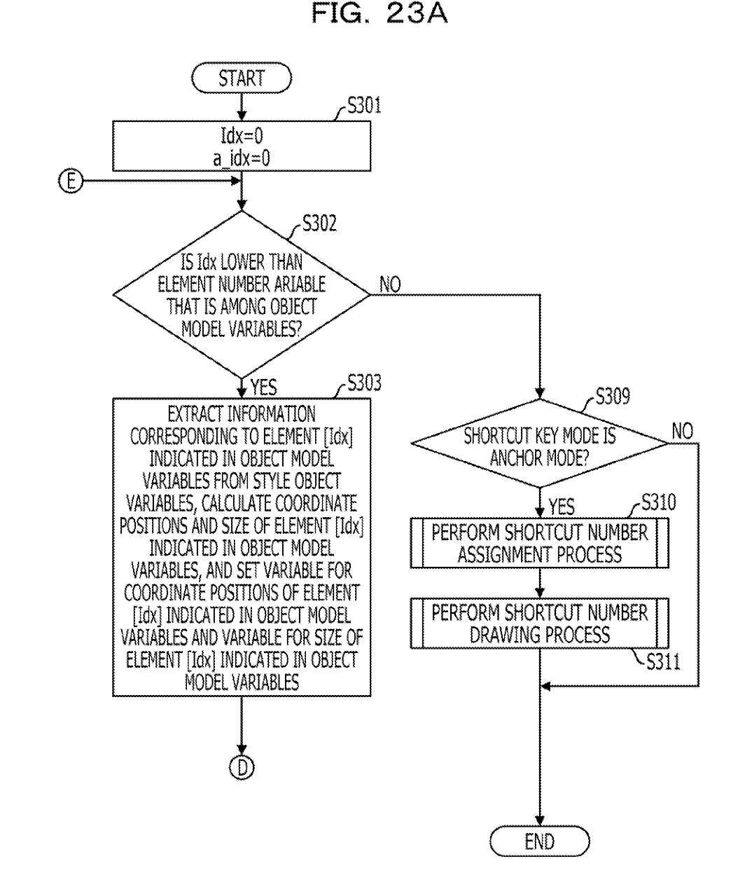

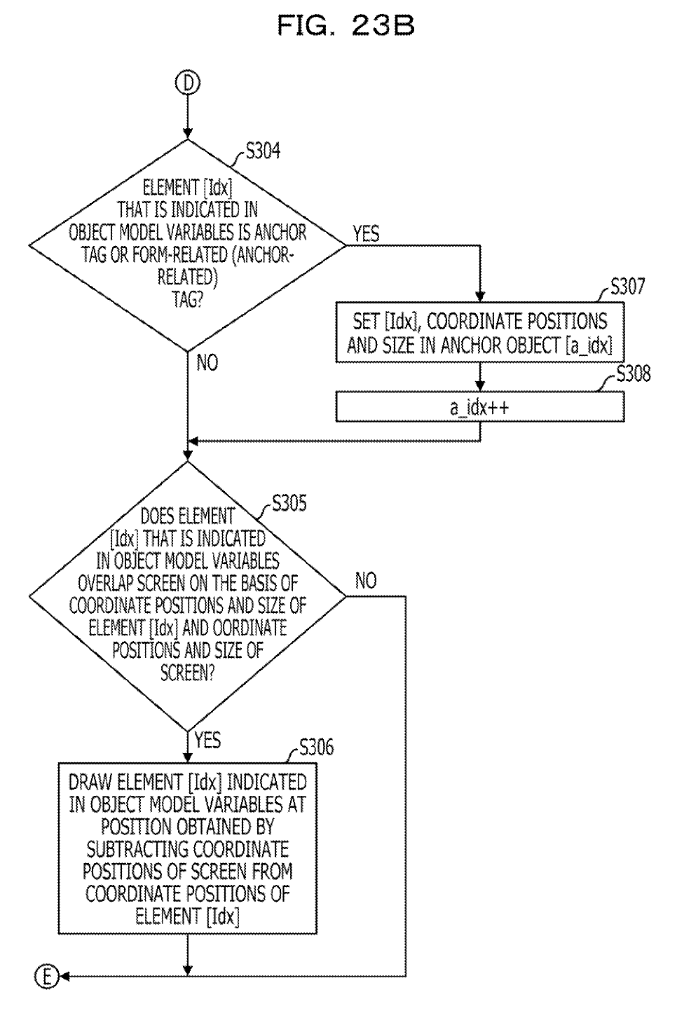

FIGS. 23A and 23B illustrate an example of procedures of the drawing process. In FIGS. 23A and 23B, D and E indicate connections between flowcharts of FIGS. 23A and 23B.

The drawing process is a browser drawing process. Setting of an anchor object is added to the process of drawing an HTML content in order to set a shortcut. The results of the HTML analysis are stored as the object model variables and the style object variables. The HTML content is drawn on a display using these information pieces. In the present embodiment, after the HTML content is drawn, the shortcut numbers are drawn.

In the drawing process, Idx is set to 0 and a_idx is set to 0 (in step S301) as illustrated in FIGS. 23A and 23B, and an HTML content is drawn on the basis of the object model variables and the style object variables.

Then, Idx is compared with an element number variable that is among the object model variables (in step S302). When Idx is lower than the element number variable that is among the object model variables as a result of the comparison (Yes in step S302), information is extracted from the style object variables, the coordinate positions and size of the element [Idx] are calculated, and a variable for the coordinate positions and a variable for the size are set (in step S303). Specifically, in step S303, the information that corresponds to the element [Idx] indicated in the object model variables is extracted from the style object variables. The coordinate positions and size of the element [Idx] that is indicated in the object model variables are calculated. Then, a variable for the coordinate positions of the element [Idx] indicated in the object model variables, and a variable for the size of the element [Idx] indicated in the object model variables, are set.

It is determined whether the element [Idx] that is indicated in the object model variables is an anchor tag or a form-related (anchor-related) tag (in step S304). When the element [Idx] that is indicated in the object model variables is not the anchor tag and the form-related tag (No in step S304), the process proceeds to step S305. In step S305, it is determined whether or not the element [Idx] that is indicated in the object model variables overlaps the screen on the basis of the coordinate positions and size of the element [Idx] and the coordinate positions and size of the screen.

In order to determine whether or not the element [Idx] overlaps the screen (in step S305), the coordinate positions x and y of the element, the lengths xL and yL of the element, the coordinate positions xscr and yscr of the screen and the lengths xLscr and yLscr of the screen are used. When x+xL<xscr or x>xscr+xLscr, and y+yL<yscr or y>yscr+yLscr, it is determined that the element [Idx] does not overlap the screen.

When it is determined that the element [Idx] that is indicated in the object model variables overlaps the screen on the basis of the coordinate positions and size of the element [Idx] and the coordinate positions and size of the screen (Yes in step S305), the process proceeds to step S306. In step S306, the element [Idx] that is indicated in the object model variables is drawn at a position obtained by subtracting the coordinate positions of the screen from the coordinate positions of the element [Idx]. Then, the process returns to step S302. When it is determined that the element [Idx] that is indicated in the object model variables does not overlap the screen on the basis of the coordinate positions and size of the element [Idx] and the coordinate positions and size of the screen (No in step S305), the process returns to step S302.

When the element [Idx] that is indicated in the object model variables is either the anchor tag or the form-related tag (Yes in step S304), the process proceeds to step S307. In this case, Idx, the coordinate positions of the element [Idx] and the size of the element [Idx] are set in an anchor object [a_idx] (in step 307), and the process is performed on a_idx++ (in step S308). Then, the process proceeds to step S305.

In addition, when Idx is not lower than the element number variable that is among the object model variables (No in step S302), it is determined whether or not a shortcut key mode is an anchor mode (in step S309). When the shortcut key mode is the anchor mode (Yes in step S309), a shortcut number assignment process is performed (in step S310).

The shortcut key mode of the shortcut number assignment process (step S310) has the anchor mode and a normal mode. In the anchor mode, an operation is performed when an assigned anchor is selected by pressing a numeric keypad. In the normal mode, various functions are assigned to shortcuts, and an assigned function is executed by pressing the numeric keypad. For example, if the number “1” is assigned to an operation of enlarging the screen and pressed, the screen is enlarged. The shortcut key mode can be switched by the off-hook key.

After the shortcut number assignment process, a shortcut number drawing process is performed (in step S311), and the process illustrated in FIGS. 23A and 23B are terminated. In addition, when the shortcut key mode is not the anchor mode (No in step S309), the process illustrated in FIGS. 23A and 23B are terminated. Thus, only in the anchor mode, a shortcut key is assigned to an anchor and drawn.

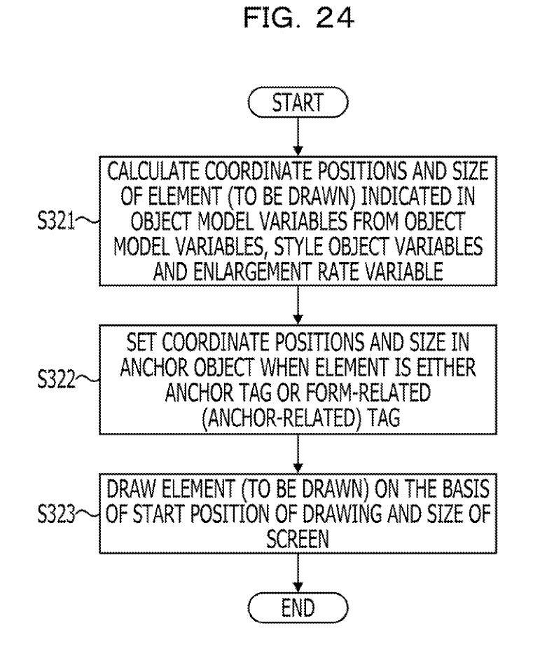

FIG. 24 illustrates procedures of a process of setting an anchor object.

The process illustrated in FIG. 24 is a subroutine of step S307 (illustrated in FIG. 23). As illustrated in FIG. 24, the coordinate positions and size of the element that is indicated in the object model variables are calculated from the object model variables, the style object variables and an enlargement rate variable (in step S321).

When the element is the anchor tag or the form-related (anchor-related) tag, the coordinate positions and size of the element are set in the anchor object (in step S322).

Then, the element to be drawn is drawn on the basis of the set coordinate positions and the set size (in step S323), and the process returns to the aforementioned step S307 (illustrated in FIG. 23).

Shortcut Assignment Process

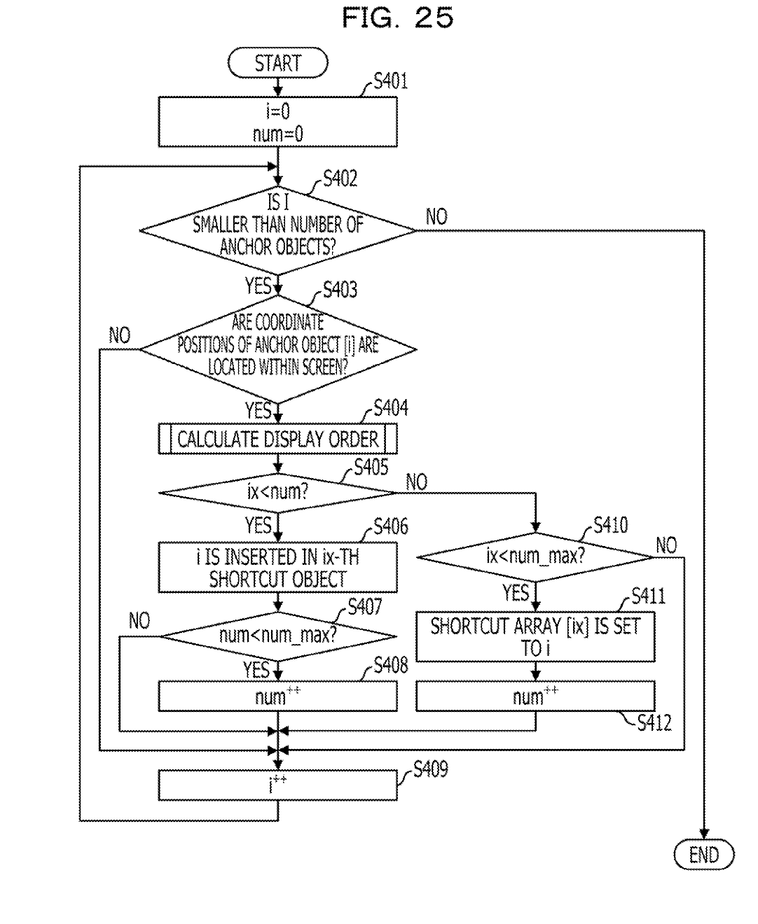

FIG. 25 illustrates an example of procedures of a shortcut assignment process.

The shortcut assignment process is or includes a process of calculating a display order for anchors (to be displayed) that are among anchor objects set in the HTML drawing process and are drawn, and arranging the anchors sorted in the display order that corresponds to an array of shortcuts.

In the shortcut assignment process, i is initialized and set to 0, and a number num is initialized and set to 0 as illustrated in FIG. 25 (in step S401). The number num is the number of set shortcut objects, while num_max is the upper limit of the number of set shortcut objects. When a switching function is not installed, the upper limit of the number of set shortcut objects is set to 10. When the switching function is installed, the upper limit of the number of set shortcut objects is set to an upper limit (for example, 100) for implementation.

After step S401, it is determined that a variable i is lower than the number of anchor objects (in step S402). When the variable i is lower than the number of the anchor objects (Yes in step S402), it is determined whether or not the coordinate positions of an anchor object [i] are located within the screen (in step S403). When the drawing coordinate positions of the anchor object [i] are located within the screen (Yes in step S403), a process of calculating a display order is performed (in step S404). In step S404, the order of displaying anchor objects [i] is calculated, and i is set to ix.

After the process of calculating the display order, it is determined whether or not ix<num (in step S405). When ix<num (Yes in step S405), i is inserted in the ix-th shortcut object (in step S406). It is determined whether or not num<num_max (in step S407). When num<num_max (Yes in step S407), the number num is set to num++ (in step S408), i is set to i++ (in step S409), and the process returns to step S402.

When ix≧num (No in step S405), it is determined whether or not ix<num_max (in step S410). When ix<num_max (Yes in step S410), a shortcut array [ix] is set to i (in step S411), the number num is set to num++ (in step S412), i is set to i++ (in step S409), and the process returns to step S402. When at least one of the coordinate positions of the anchor object [i] is not located within the screen (No in step S403), the process proceeds to step S409 without performing steps S404 to S408 and S410 to S412. When num≧num_max (No in step S407), the process proceeds to step S409 without performing step S408. Then, the process of step S409 is performed, and the shortcut assignment process returns to step S402. When ix≧num_max (No in step S410), the process proceeds to step S409. Then, the process of step S409 is performed and the shortcut assignment process returns to step S402.

Then, when i≧the number of the anchor objects (No in step S402), the shortcut assignment process is terminated.

Process of Calculating Display Ranking

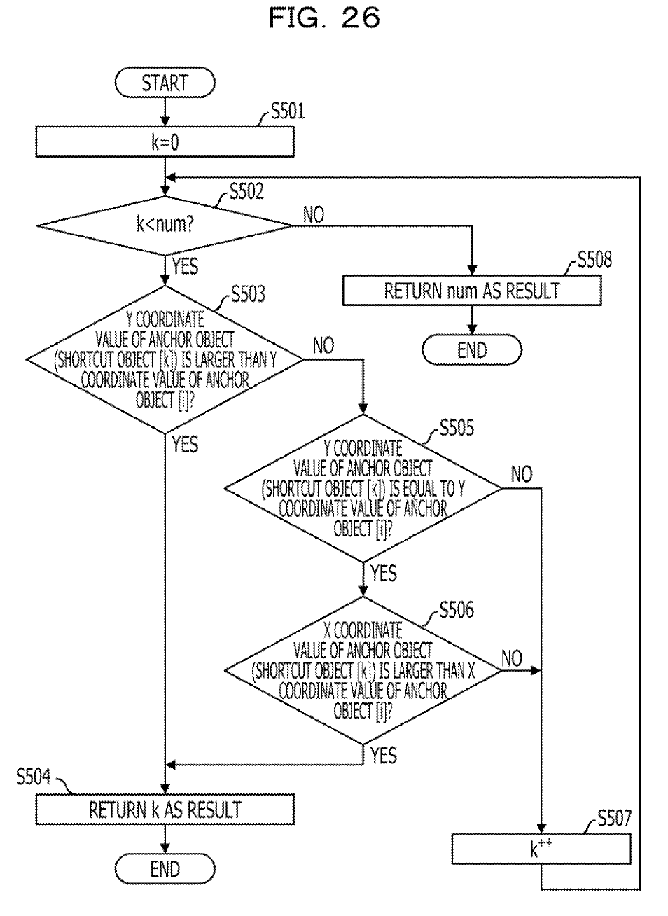

FIG. 26 illustrates an example of procedures of the process of calculating the display order.

In the process of calculating the display order, the leftmost and uppermost point of the screen is treated as the point of origin, and the display order is calculated so that an object that has a smaller Y coordinate value is prioritized. When objects have the same Y coordinate value, the display order is calculated so that an object that has a smaller X coordinate value is prioritized. The leftmost and uppermost point of the screen is treated as the point of origin as described above. As an object is closer to the lowest point of the screen, the Y coordinate value of the object is larger. As the object is closer to the rightmost point of the screen, the X coordinate value of the object is larger.

In the process procedures illustrated in FIG. 26, k is initialized and set to 0 (in step S501), and it is determined whether or not k<num (in step S502). When k<num (Yes in step S502), it is determined whether or not the Y coordinate value of an anchor object (shortcut object [k]) is larger than the Y coordinate value of the anchor object [i] (in step S503).

When the Y coordinate value of the anchor object (shortcut object [k]) is larger than the Y coordinate value of the anchor object [i] (Yes in step S503), k is returned as the result (in step S504), and the process illustrated in FIG. 26 is terminated.

When the Y coordinate value of the anchor object (shortcut object [k]) is not larger than the Y coordinate value of the anchor object [i] (No in step S503), the process proceeds to step S505. In step S505, it is determined whether or not the Y coordinate value of the anchor object (shortcut object [k]) is equal to the Y coordinate value of the anchor object [i]. When the Y coordinate value of the anchor object (shortcut object [k]) is equal to the Y coordinate value of the anchor object [i] (Yes in step S505), the process proceeds to step S506. In step S506, it is determined whether or not the X coordinate value of the anchor object (shortcut object [k]) is larger than the X coordinate value of the anchor object [i]. When the X coordinate value of the anchor object (shortcut object [k]) is larger than the X coordinate value of the anchor object [i] (Yes in step S506), the process proceeds to step S504.

When the Y coordinate value of the anchor object (shortcut object [k]) is not equal to the Y coordinate value of the anchor object [i] (No in step S505), k is set to k++ (in step S507) and the process returns to step S502.

When the X coordinate value of the anchor object (shortcut object [k]) is not larger than the X coordinate value of the anchor object [i] (No in step S506), k is set to k++ (in step S507) and the process returns to step S502.

When k exceeds num, or when k num (No in step S502), num is returned as the result (in step S508) and the process illustrated in FIG. 26 is terminated.

Shortcut Number Drawing Process

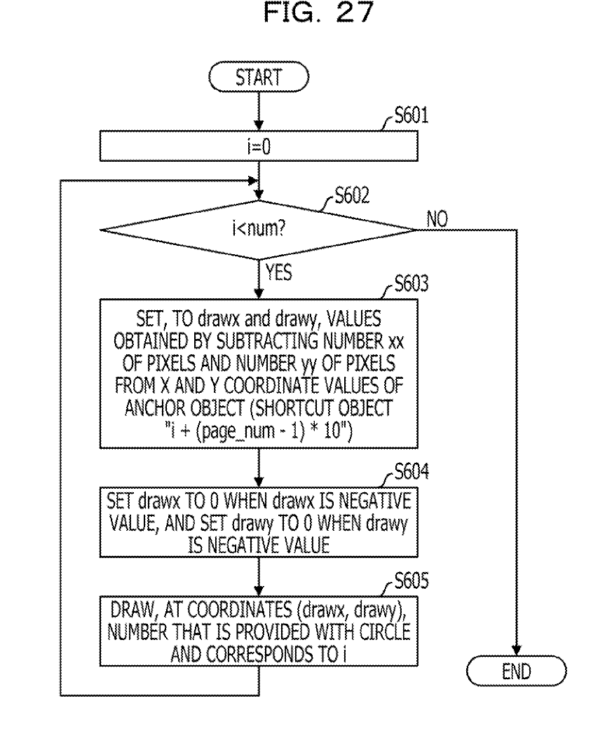

FIG. 27 illustrates an example of procedures of a shortcut number drawing process.

The shortcut number drawing process is a process of drawing a shortcut number 120 on the upper right side of an anchor 10 corresponding to the shortcut number 120 so as to cause the shortcut number 120 to slightly overlap the anchor 10.

When the shortcut number drawing process starts, i is initialized and set to 0 (in step S601). Then, it is determined whether or not i<num (in step S602). When i<num (Yes in step S602), the coordinate positions of the shortcut number 120 are set (in step S603).

In the setting of the coordinate positions of the shortcut number 120, values that are obtained by subtracting a number xx of pixels and a number yy of pixels from the X and Y coordinate values of an anchor object (shortcut object “i+(page_num−1)*10”) are set to coordinate values drawx and drawy. In this case, the numbers xx and yy are setting values to be used to correct the coordinate values of the shortcut number 120 to be drawn. In addition, page_num indicates a shortcut switching page (1 indicates the first to tenth anchors; 2 indicates the eleventh to twentieth anchors; . . . ).

After the setting of the coordinate positions of the shortcut number 120 to be drawn, when at least one of the set coordinate positions is located outside the screen, the coordinate position is corrected (in step S604). Specifically, when the coordinate value drawx is a negative value, the coordinate value drawx is set to 0. When the coordinate value drawy is a negative value, the coordinate value drawy is set to 0.

Then, a shortcut number that is provided with a circle (surrounding the shortcut number) and corresponds to the aforementioned i is drawn at the coordinates (drawx, drawy), and the process returns to step S602. When i exceeds num, or when i≧num (No in step S602), the process illustrated in FIG. 27 is terminated.

Event Waiting State

FIGS. 28A to 28C illustrate an example of procedures of a process that is performed when the mobile terminal device is in the event waiting state. In FIGS. 28A to 28C, A and B indicate connections between flowcharts of FIGS. 28A and 28B. C indicates connection between flowcharts of FIGS. 28A and 28C.

The procedures of the process that is performed when the mobile terminal device is in the event waiting state include a redrawing process (such as reading of an HTML file) to be performed by specifying screen scrolling, display enlargement or a name tag.

The process procedures (sequence) are procedures that are performed when a key event occurs during the time when the mobile terminal device is in the event waiting state. When any of events (other than a key event) such as a disconnection of communication and a forced termination occurs, the process procedures are performed. In the example of the process procedures, mode switching using the off-hook key, shortcut switching in the anchor mode, and a shortcut operation are described (Other operations are each described using the term “process” and are thus not described in detail. The shortcut switching is a function of switching assignments of shortcut numbers to displayed anchors (assignments of shortcut numbers to the first to tenth anchors from the top, assignments of the shortcut numbers to the eleventh to twentieth anchors, and assignments of the shortcut numbers to the twenty first to thirtieth anchors) using a “*” key and a “#” key.

In the process (to be performed when the mobile terminal device is in the event waiting state), when the mobile terminal device is in the event waiting state, a key event is received (in step S701), and it is determined whether or not the key event occurs by pressing the off-hook key (in step S702) as illustrated in FIG. 28A. In this case, the off-hook key switches the shortcut key mode between the anchor mode and the normal mode.

When the key event occurs by pressing the off-hook key (Yes in step S702), it is determined whether or not the shortcut key mode is the anchor mode (in step S703). When the shortcut key mode is the anchor mode (Yes in step S703), the shortcut key mode is set to the normal mode (in step S704), the drawing process is performed (in step S705), and the mobile terminal device becomes the event waiting state.

When the shortcut key mode is not the anchor mode (No in step S703), it is determined whether or not num>0 (in step S706). When num>0 (Yes in step S706), the shortcut key mode is set to the anchor mode (in step S707), page_num is set to 1 (in step S708), and the drawing process is performed (in step S709). After that, the mobile terminal device becomes the event waiting state. When num≦0 (No in step S706), the mobile terminal device becomes the event waiting state.

When the key event does not occur from the off-hook key (No in step S702), it is determined that the shortcut key mode is the anchor mode (in step S710).

When the shortcut key mode is the anchor mode (Yes in step S710), it is determined whether or not the key event occurs by pressing any of the number keys 0 to 9 (in step S711). When any of the number keys 0 to 9 is pressed so that the key event occurs (Yes in step S711), a number is calculated from a code value of the pressed number key (when the number key “0” is pressed so that the key event occurs, the code value is “0”; when the number key “1” is pressed so that the key event occurs, the code value is “1”; . . . ), and the calculated number is set to key_num (in step S712). In addition, anchor information of an anchor object (shortcut object (key_num+(page_num−1)*10) is acquired (in step S713), an HTML file that corresponds to the anchor information is acquired (in step S714). Then, the acquired HTML file is analyzed (in step S715), and the drawing process is performed (in step S716). Then, the mobile terminal device becomes the event waiting state.

When a key other than the number keys 0 to 9 is pressed so that the key event occurs (No in step S711), it is determined whether or not the pressed key is the “*” key (in step S717). When the pressed key is the “*” key (Yes in step S717), it is determined whether or not page_num>1 (in step S718). When page_num>1 (Yes in step S718), page_num—is set (in step S719) and the drawing process is performed (in step S720). Then, the mobile terminal device becomes the event waiting state. On the other hand, when page_num≦1 (No in step S718), the mobile terminal device becomes the event waiting state.

When the pressed key is not the “*” key (No in step S717), it is determined whether or not the pressed key is the “#” key (in step S721). When the pressed key is the “#” key (Yes in step S721), it is determined whether or not page_num<int((num+9)/10) (in step S722). When page_num<int((num+9)/10) (Yes in step S722), page_num is set to page_num++ (in step S723), and the drawing process is performed (in step S724). Then, the mobile terminal device becomes the event waiting state. On the other hand, when page_num≧int((num+9)/10) (No in step S722), the mobile terminal device becomes the event waiting state.

When the shortcut key mode is not the anchor mode (No in step S710), it is determined whether or not the key operation is performed by any of the cursor keys (in step S725 illustrated in FIG. 28B). When the key operation is performed by any of the cursor keys (Yes in step S725), it is determined whether or not the mobile terminal device is in a pointer display mode (in step S726).

When the mobile terminal device is in the pointer display mode (Yes in step S726), a pointer moves according to a pressed cursor key among the cursor keys (in step S727). When the pointer is located at an edge of the screen, the screen is scrolled (in step S728), the drawing process is performed (in step S729), and the mobile terminal device becomes the event waiting state. On the other hand, when the mobile terminal device is not in the pointer display mode (No in step S726), a focus moves according to the pressed cursor key among the cursor keys (in step S730). When the focus is located outside the screen, the screen is scrolled (in step S731), the drawing process is performed (in step S732), and the mobile terminal device becomes the event waiting state.

When the key operation is not performed by any of the cursor keys (No in step S725), it is determined whether or not the pressed key that corresponds to the key operation is a key that is provided to display a submenu (in step S733). When the pressed key is the key that is provided to display the submenu (Yes in step S733), the submenu is displayed (in step S734), and the mobile terminal device becomes the event waiting state.

When the pressed key is not the key that is provided to display the submenu (No in step S733), it is determined whether or not the pressed key is a key for scrolling-up (in step S735). When the pressed key is the key for scrolling-up (Yes in step S735), a page is scrolled up (in step S736), and the drawing process is performed (in step S737). After the drawing process, the mobile terminal device becomes the event waiting state.

When the pressed key is not the key for scrolling-up (No in step S735), it is determined whether or not the pressed key is a key for scrolling-down (in step S738). When the pressed key is the key for scrolling-down (Yes in step S738), the page is scrolled down (in step S739), and the drawing process is performed (in step S740). After the drawing process, the mobile terminal device becomes the event waiting state.

When the pressed key is not the key for scrolling-down (No in step S738), it is determined whether or not the pressed key is a key for terminating the browser (in step S741). When the pressed key is the key for terminating the browser (Yes in step S741), a process of terminating the browser is performed (in step S742) and the process illustrated in FIGS. 28A to 28C is terminated. On the other hand, when the pressed key is not the key for terminating the browser (No in step S741), the mobile terminal device becomes the event waiting state.

In the processes that are included in the process procedures illustrated in FIGS. 28A to 28C and correspond to the anchor information, the selection of an anchor causes a page transition. The page transition causes the processes from the acquisition of an HTML file to the drawing process to be performed. In the processes (steps 725 to 742 (illustrated in FIG. 28B) to be performed when the answer is No in step S710) other than the processes corresponding to the shortcut key or other than the processes to be performed in the anchor mode, the selection of an anchor causes a page transition (causing the processes from the acquisition of an HTML file to the drawing process to be performed). In the processes (steps 725 to 742 (illustrated in FIG. 28B)), a displayed content is changed by any of upper and lower keys and scroll keys, and the drawing process is performed.

Drawing Process (Embedding Process)

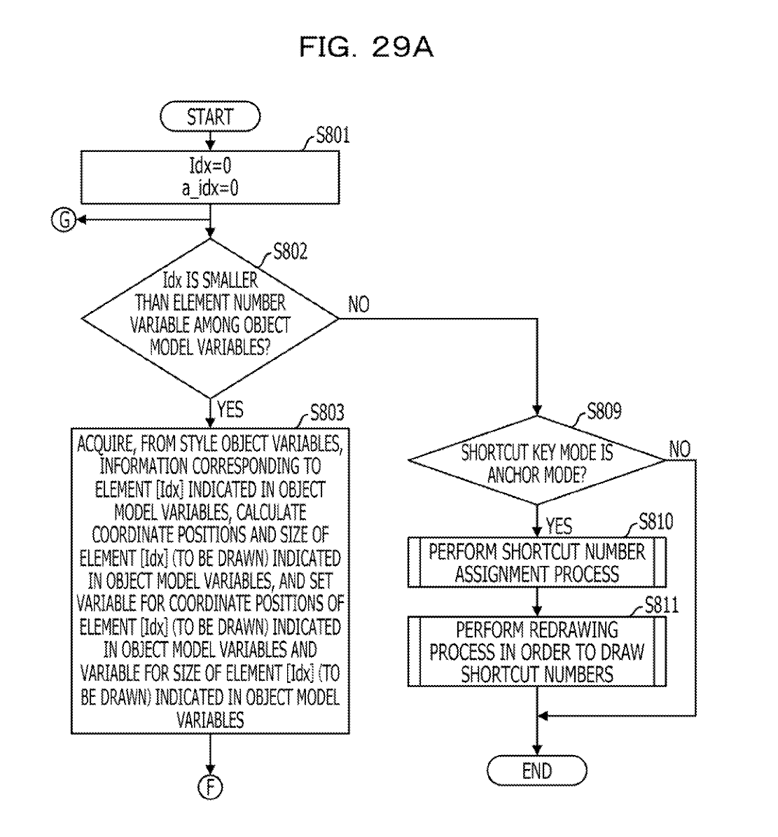

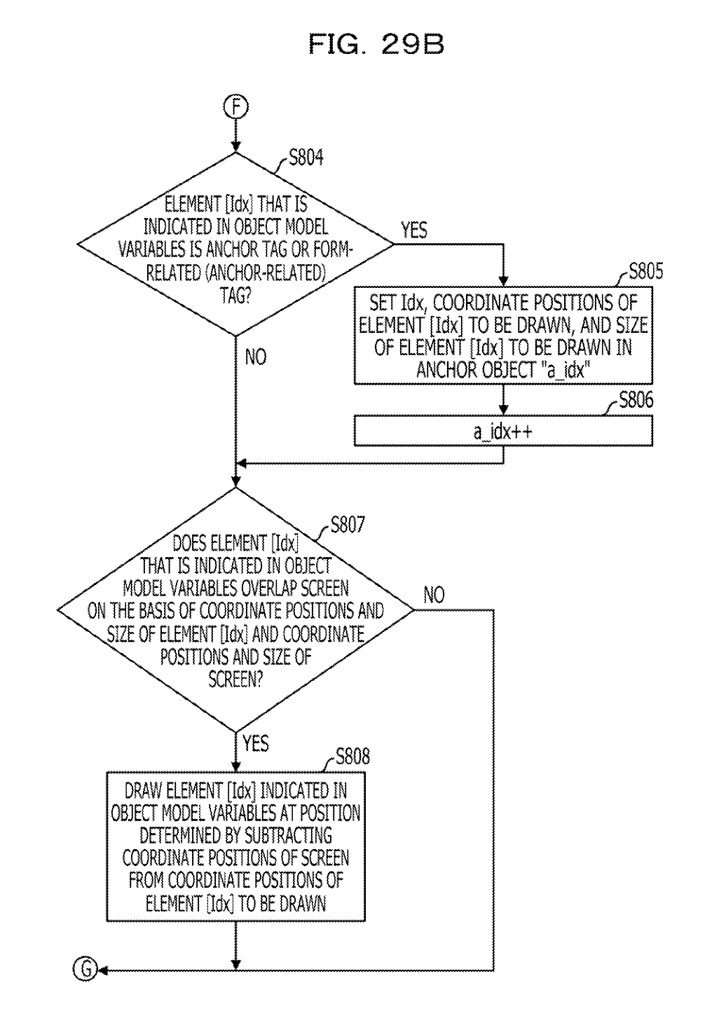

FIGS. 29A and 29B illustrate an example of procedures of the drawing process. In FIGS. 29A and 29B, F and G indicate connections between flowcharts of FIGS. 29A and 29B.

In the drawing process, a content that is described in HTML is first drawn, coordinate positions of an element to be drawn are specified, and anchors in which shortcut numbers are embedded are calculated. After that, the entire screen is drawn, while the shortcut numbers are embedded. It is preferable that drawing for positioning be performed using a buffer storing data that is not displayed, instead of a normal screen buffer. When the display is performed using the screen buffer for storing data to be displayed, flickering or the like can be prevented.

In the process procedures, after the content that is described in HTML is drawn, the process of drawing the shortcut numbers is performed. In the process procedures, as illustrated in FIGS. 29A and 29B, when the drawing process starts, Idx is set to 0 and a_idx is set to 0 (in step S801). The content that is described in HTML is drawn on the basis of the object model variables and the style object variables. It is determined whether or not Idx is smaller than the element number variable that is among the object model variables (in step S802).

When Idx is smaller than the element number variable that is among the object model variables (Yes in step S802), the coordinate positions and size of the element [Idx] to be drawn are calculated, and the variable for the coordinate positions of the element [Idx] and the variable for the size of the element [Idx] are set (in step S803). In this process, information that corresponds to the element [Idx] indicated in the object model variables is acquired from the style object model variables. The coordinate positions and size of the element [Idx] (to be drawn) indicated in the object model variables are calculated. Then, the variable for the coordinate positions of the element [Idx] (to be drawn) indicated in the object model variables and the variable for the size of the element [Idx] (to be drawn) indicated in the object model variables are set.

After this process, it is determined whether or not the element [Idx] that is indicated in the object model variables is either an anchor tag or a form-related (anchor-related) tag (in step S804). When the element [Idx] that is indicated in the object model variables is either the anchor tag or the form-related (anchor-related) tag (Yes in step S804), the process proceeds to step S805. Then, Idx, the coordinate positions of the element [Idx] to be drawn and the size of the element [Idx] to be drawn are set in the anchor object [a_idx] (in step S805), and a_idx is set to a_idx++ (in step S806). Then, the process proceeds to step S807. When the element [Idx] that is indicated in the object model variables is not the anchor tag and the form-related (anchor-related) tag (No in step S804), the process proceeds to step S807.

In step S807, it is determined determines whether or not the element [Idx] that is indicated in the object model variables overlaps the screen on the basis of the coordinate positions and size of the element [Idx] and the coordinate positions and size of the screen. When the element [Idx] that is indicated in the object model variables overlaps the screen on the basis of the coordinate positions and size of the element [Idx] and the coordinate positions and size of the screen (Yes in step S807), the element [Idx] that is indicated in the object model variables is drawn at a position determined by subtracting the coordinate positions of the screen from the coordinate positions of the element [Idx] to be drawn (in step S808). Then, the process proceeds to step S802. On the other hand, when the element [Idx] that is indicated in the object model variables does not overlap the screen on the basis of the coordinate positions and size of the element [Idx] and the coordinate positions and size of the screen (No in step S807), the process proceeds to step S802.

When Idx is not smaller than the element number variable that is among the object model variables (No in step S802), it is determined whether or not the shortcut key mode is the anchor mode (in step S809).

When the shortcut key mode is the anchor mode (Yes in step S809), the shortcut number assignment process is performed (in step S810), and the redrawing process is performed in order to draw the shortcut numbers (in step S811). Then, the process illustrated in FIGS. 29A and 29B are terminated. When the shortcut key mode is not the anchor mode (No in step S809), the process illustrated in FIGS. 29A and 29B are terminated.

In the shortcut number assignment process (step S810), the shortcut keys are assigned to anchors and drawn only when the shortcut key mode is the anchor mode.

Redrawing Process to be Performed for Drawing of Shortcut Numbers

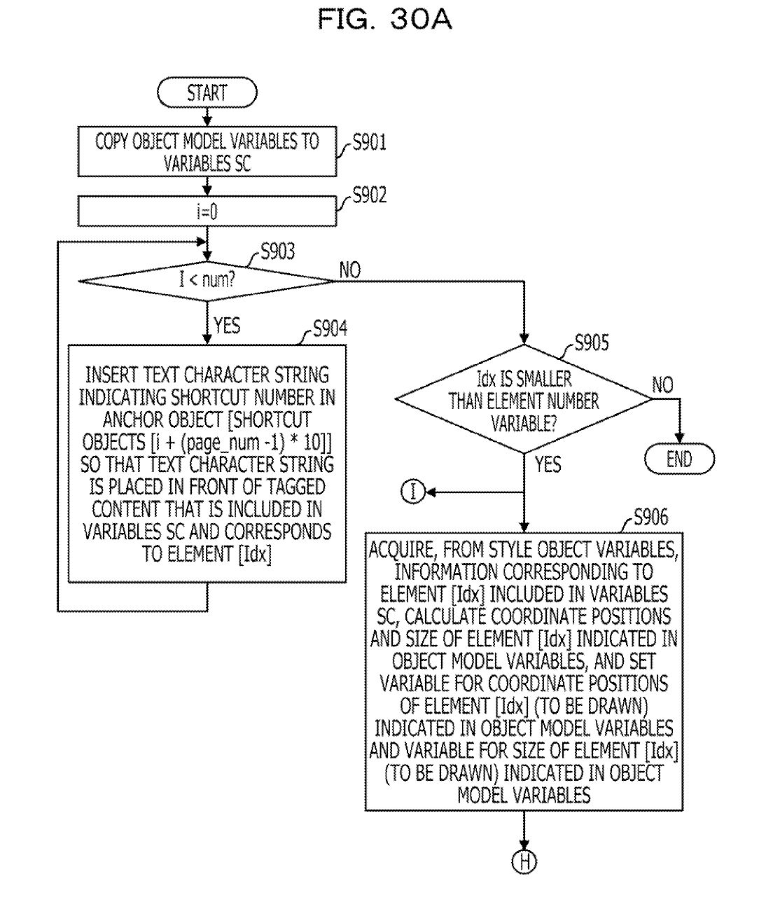

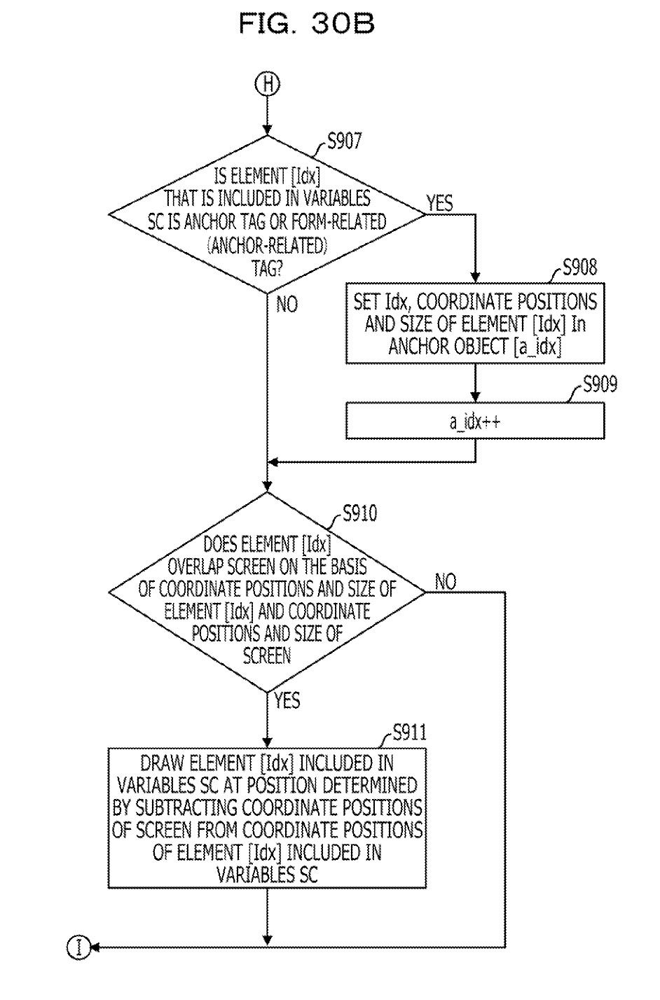

FIGS. 30A and 30B illustrate an example of procedures of the redrawing process to be performed in order to draw the shortcut numbers. In FIGS. 30A and to 30B, H and I indicate connections between flowcharts of FIGS. 30A and 30B.

In the process procedures illustrated in FIGS. 30A and 30B, the shortcut numbers are embedded, and the drawing is performed on the entire screen. In the process procedures illustrated in FIGS. 30A and 30B, the object model variables are copied to variables SC (in step S901). The original object model variables may not be used without a change since a text character string is inserted so that a content is changed. Thus, the object model variables are copied to the variables SC and used.

Then, i is set to 0 (in step S902) and it is determined whether or not i<num (in step S903). When i<num (Yes in step S903), the process proceeds to step S904. In step S904, a text character string that indicates a shortcut number is inserted in the anchor object [shortcut objects [i+(page_num−1)*10]] and placed in front of a tagged content that is indicated in the variables SC and correspond to the element [Idx]. The text character string to be inserted is a character string that is constituted by three characters (such as [0], [1], . . . , or [9]) that are a one-byte number and two brackets.

When i≧num (No in step S903), it is determined whether or not Idx is smaller than the element number variable among the variables SC (in step S905). Thus, after the shortcut numbers are embedded, the content that is described in HTML is drawn.

When Idx is smaller than the element number variable (Yes in step S905), the process proceeds to step S906. In step S906, information that corresponds to the element [Idx] indicated in the variables SC is acquired from the style object variables, and the coordinate positions and size of the element [Idx] indicated in the object model variables are calculated. Then, the variable for the coordinate positions of the element [Idx] (to be drawn) indicated in the object model variables and the variable for the size of the element [Idx] (to be drawn) indicated in the object model variables are set.

Then, it is determined whether or not the element [Idx] that is indicated in the variables SC is either an anchor tag or a form-related (anchor-related) tag (in step S907). When the element [Idx] that is indicated in the variables SC is either the anchor tag or the form-related (anchor-related) tag (Yes in step S907), Idx and the coordinate positions and size of the element [Idx] to be drawn are set in the anchor object [a_idx] (in step S908), and a_idx is set to a_idx++ (in step S909). Then, the process proceeds to step S910. On the other hand, when the element [Idx] that is indicated in the variables SC is not the anchor tag and the form-related (anchor-related) tag (No in step S907), the process proceeds to step S910.

In step S910, it is determined whether or not the element [Idx] that is indicated in the variables SC overlaps the screen on the basis of the coordinate positions and size of the element [Idx] indicated in the variables SC and the coordinate positions and size of the screen. When the element [Idx] that is indicated in the variables SC overlaps the screen on the basis of the coordinate positions and size of the element [Idx] indicated in the variables SC and the coordinate positions and size of the screen (Yes in step S910), the element [Idx] that is indicated in the variables SC is drawn at a position determined by subtracting the coordinate positions of the screen from the coordinate positions of the element [Idx] (in step S911). Then, the process returns to step S905. On the other hand, when the element [Idx] that is indicated in the variables SC does not overlap the screen on the basis of the coordinate positions and size of the element [Idx] indicated in the variables SC and the coordinate positions and size of the screen (No in step S910), the process returns to step S905.

When Idx is not smaller than the element number variable that is indicated the variables SC (No in step S905), the process illustrated in FIGS. 30A and 30B are terminated.

According to the second embodiment, the shortcut assignment is performed not only when data described in HTML/XHTML is read but also when a drawn content is changed such as when the screen is scrolled, enlarged, reduced, and when data that is described in HTML/XHTML and in which a name tag is specified is read. Thus, a shortcut can be assigned to an anchor displayed on the screen regardless of the time. Therefore, even when data that is described in HTML or XHTML and includes a lot of anchors is displayed, shortcuts can be assigned to a lot of anchors.

### Third Embodiment

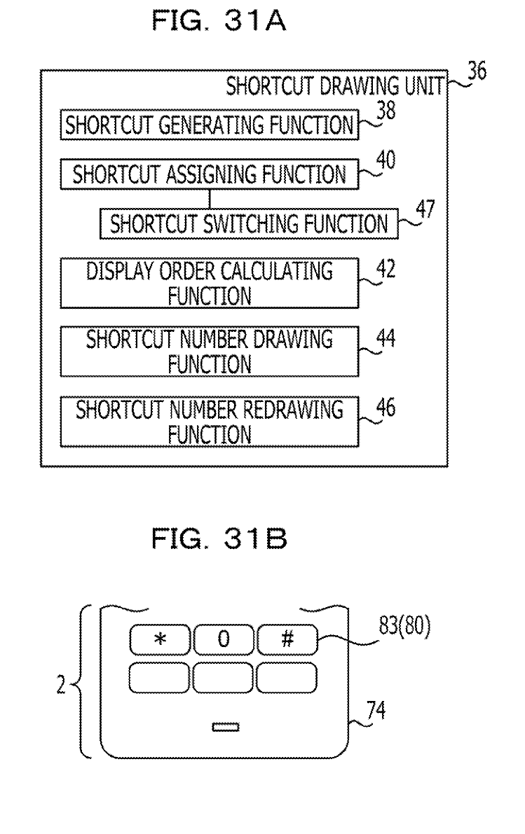

In the aforementioned embodiments, ten shortcut numbers 120 are assigned to ten anchors on the basis of the display of the screen 8, for example. The assignments are not limited to this. As illustrated in FIG. 31A, the shortcut drawing unit 36 of the mobile terminal device 2 may have a shortcut switching function 47 of switching assignments of shortcut numbers to anchors. The shortcut switching function 47 switches shortcut numbers 120 so that ten or more shortcut numbers 120 are assigned to anchors. In this case, a # key 83 of the operation input unit 54 is assigned to an operation of switching shortcut numbers, as illustrated in FIG. 31B.

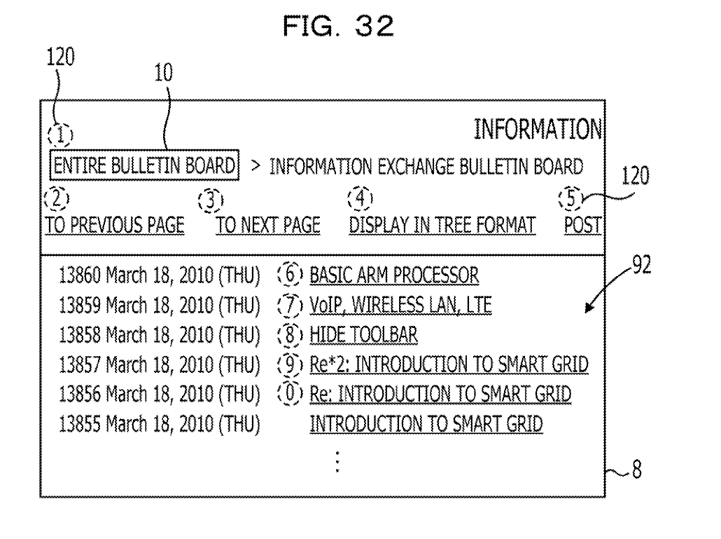

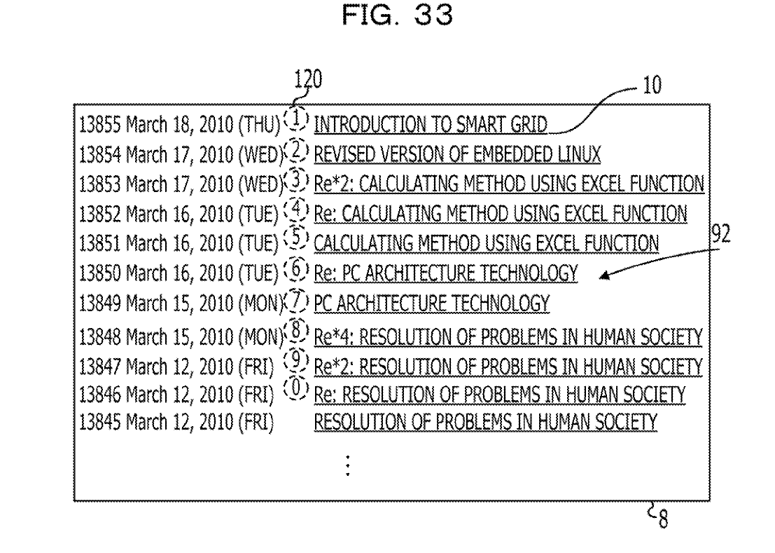

In order to switch the shortcut numbers 120, the mobile terminal device establishes communication, acquires an HTML file from a specified URL, and displays a content 92 and the shortcut numbers 120 on the screen 8 of the display unit 4 so that the shortcut numbers 120 are assigned to anchors 10 in ascending order from an anchor 10 located on the uppermost side of the content 92 as illustrated in FIG. 32. In this case, the shortcut numbers 120 are assigned to the ten anchors 10 in order from the anchor located on the uppermost side of the content 92.

When the screen 8 is maintained to be displayed as illustrated in FIG. 32 and the # key 83 is pressed (the first pressing of the # key 83), the display of the anchors 10 is changed, and the assignments of the shortcut numbers 120 are switched as illustrated in FIG. 33. Thus, the shortcut numbers 120 are assigned to anchors 10 that are different from the anchors 10 to which the shortcut numbers 120 have been assigned as illustrated in FIG. 32. In this case, the shortcut numbers 120 are assigned to the ten anchors 10 in ascending order from an anchor 10 located on the uppermost side of the screen 8.

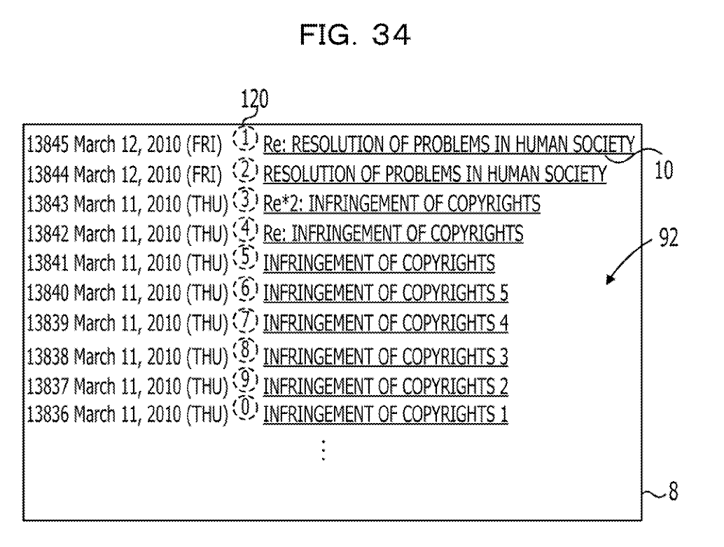

When the screen 8 is maintained to be displayed as illustrated in FIG. 33 and the # key 83 is pressed (the second pressing of the # key 83), the display of the anchors 10 is changed, and the assignments of the shortcut numbers 120 are switched as illustrated in FIG. 34. Thus, the shortcut numbers 120 are assigned to anchors 10 that are different from the anchors 10 to which the shortcut numbers 120 have been assigned as illustrated in FIG. 33. In this case, the shortcut numbers 120 are assigned to the ten anchors 10 in ascending order from an anchor 10 located on the uppermost side of the screen 8 (illustrated in FIG. 34).

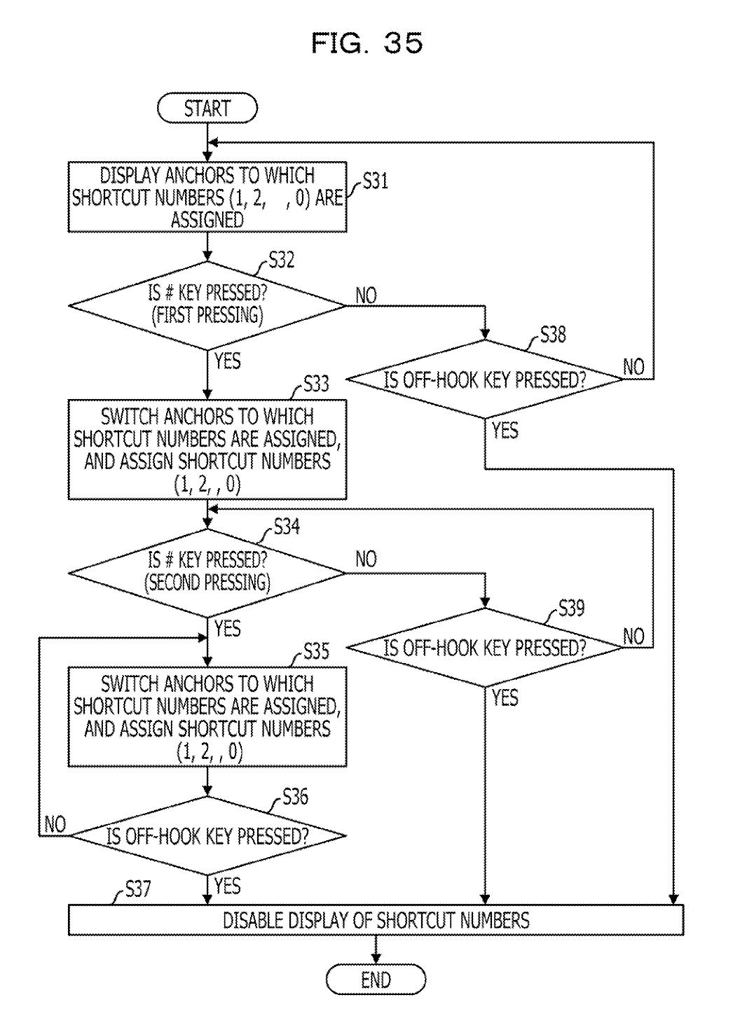

Procedures of the process of switching assignments of the shortcut numbers 120 are described with reference to FIG. 35. FIG. 35 illustrates an example of the procedures of the process of switching the shortcut numbers.

The process procedures illustrated in FIG. 35 are an example of the information selection support program disclosed herein or an example of the information selection supporting method disclosed herein. As illustrated in FIG. 35, the mobile terminal device 2 establishes communication, acquires an HTML file from a specified URL, and displays the anchors 10 to which the shortcut numbers 120 are assigned as illustrated in FIG. 32 (in step S31).

It is determined whether or not the # key 83 is pressed while the screen 8 (illustrated in FIG. 32) is displayed (in step S32). When the # key 83 is pressed (Yes in step S32), the anchors 10 to which the shortcut numbers 120 are assigned are switched to other anchors 10. Then, the shortcut numbers 120 (1, 2, . . . , 9, 0) are assigned to the other anchors 10 so that the anchors 10 and the shortcut numbers 120 (1, 2, . . . , 9, 0) are displayed (in step S33). In this case, the screen 8 is displayed as illustrated in FIG. 33.

When the screen 8 (illustrated in FIG. 33) is maintained to be displayed, it is determined whether or not the # key 83 is pressed again (in step S34). When the # key 83 is pressed again (Yes in step S34), the anchors 10 to which the shortcut numbers 120 are assigned are switched to other anchors 10. Then, the shortcut numbers 120 (1, 2, . . . , 9, 0) are assigned to the other anchors 10 so that the anchors 10 and the shortcut numbers 120 (1, 2, . . . , 9, 0) are displayed (in step S35). In this case, the screen 8 is displayed as illustrated in FIG. 34.

Then, the off-hook key 84 is monitored in order to determine whether or not the off-hook key 84 is pressed (in step S36). When the off-hook key 84 is pressed (Yes in step S36), the display of the shortcut numbers is disabled (in step S37). When the off-hook key 84 is not pressed (No in step S36), the screen 8 illustrated in FIG. 34 is maintained to be displayed.

When the # key 83 is not pressed (No in step S32), it is determined whether or not the off-hook key 84 is pressed (in step S38). When the off-hook key 84 is pressed (Yes in step S38), the display of the shortcut numbers is disabled (in step S37). When the off-hook key 84 is not pressed (No in step S38), the screen 8 illustrated in FIG. 32 is maintained to be displayed.

When the # key 83 is not pressed (No in step S34), it is determined whether or not the off-hook key 84 is pressed (in step S39). When the off-hook key 84 is pressed (Yes in step S39), the display of the shortcut numbers 120 is disabled (in step S37). When the off-hook key 84 is not pressed (No in step S39), the screen 8 illustrated in FIG. 33 is maintained to be displayed.

According to the process procedures illustrated in FIG. 35, the anchors 10 to which the shortcut numbers 120 are assigned are switched by pressing the # key 83 one time so that the shortcut numbers 120 are assigned to the eleventh to twentieth anchors 10 that are displayed in this order from the uppermost side of the screen. Then, the eleventh to twentieth anchors 10 are switched by pressing the # key 83 again so that the shortcut numbers 120 are assigned to the twenty first to thirtieth anchors 10 that are displayed in this order from the uppermost side of the screen.

According to the third embodiment, shortcut numbers can be displayed for ten or more anchors, and the function of switching the assignments of the shortcut numbers can be achieved. When a content is fully displayed on a browser screen, a large number of anchors may exist. In this case, eleven or more shortcuts can be assigned to anchors, and it is possible to improve the convenience of a selection of information.

### Another Embodiment

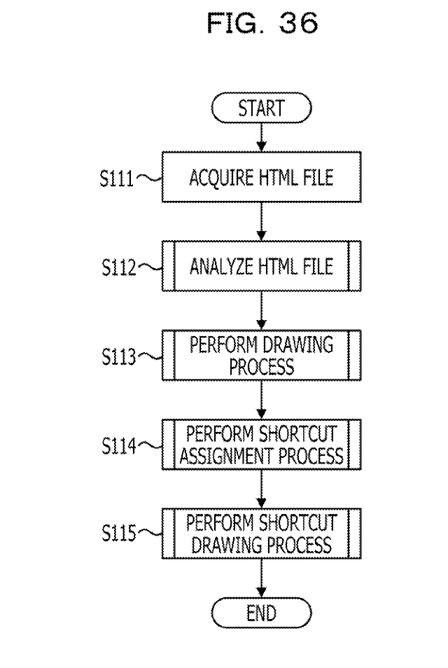

In the second embodiment, the acquisition (step S101 illustrated in FIG. 21) of the HTML file, the analysis (step S102) of the HTML file, and the drawing process (step S103) are performed in the process procedures, and the mobile terminal device waits for an event (in step S104). The process procedures, however, are not limited to this. Instead of the process procedures illustrated in FIG. 21, the process procedures illustrated in FIG. 36 may be performed. Specifically, the process procedures illustrated in FIG. 36 may be performed so that the acquisition (step S111) of the HTML file, the analysis (step S112) of the HTML file, the drawing process (step S113), the shortcut assignment process (step S114) and the shortcut drawing process (step S115) are performed in this order.

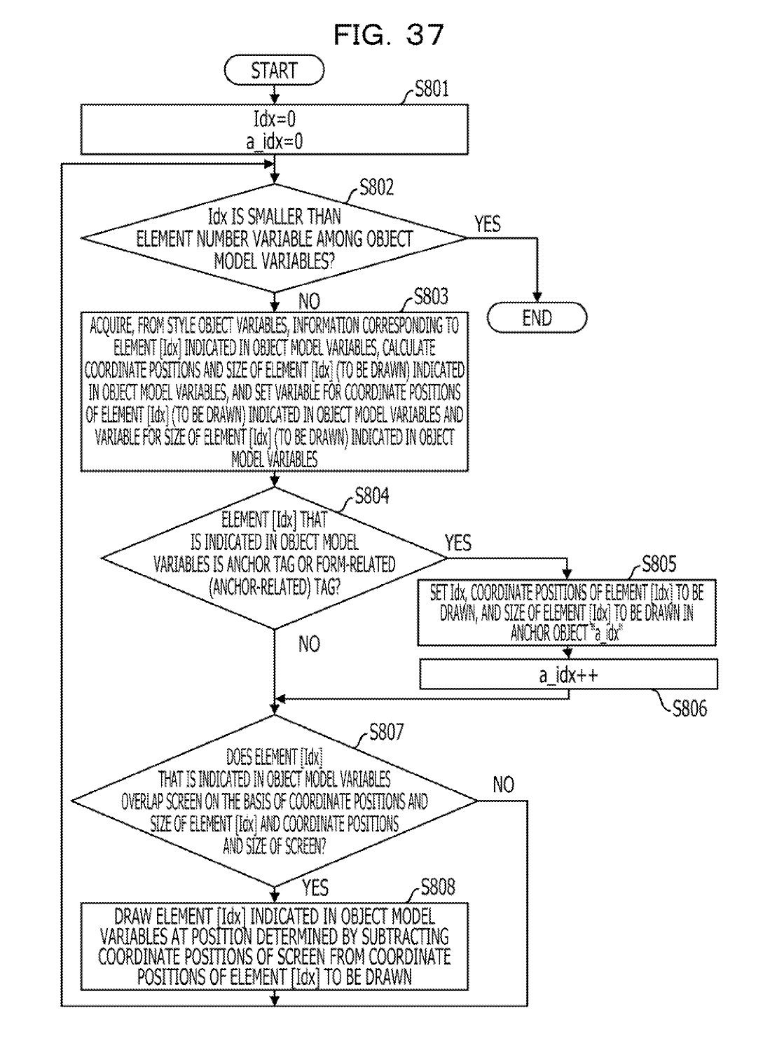

When the process procedures illustrated in FIG. 36 are to be performed, the drawing process may be changed to a drawing process illustrated in FIG. 37. Specifically, when Idx is smaller than the element number variable among the object model variables (Yes in step S802 (drawing process (embedding process)) illustrated in FIG. 29), the drawing process may be terminated.

In the aforementioned embodiments, the shortcut numbers 120 are used as the shortcuts 12 to be displayed. Characters other than the numbers, signs or figures may be used as the shortcuts 12 to be displayed. The shortcuts 12 to be displayed are selected by key inputs. However, the shortcuts 12 to be displayed may be selected by audio inputs.

When data to be drawn is not determined due to a scroll operation or the like, the shortcut numbers may not be assigned and displayed.

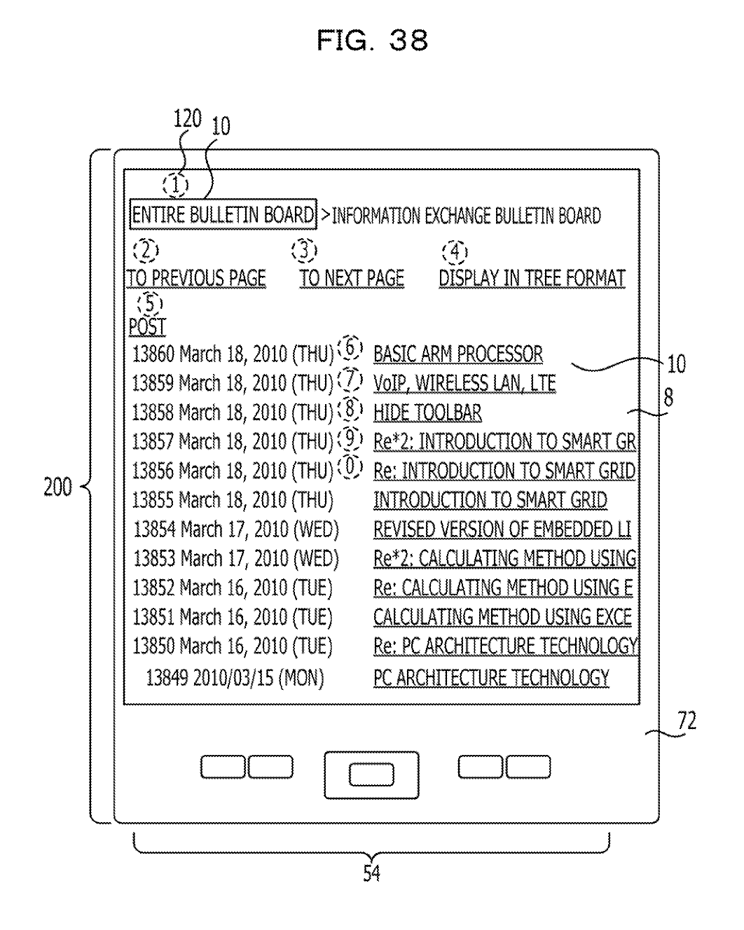

In the aforementioned embodiments, a mobile phone is used as the example of the mobile terminal device 2. However, a personal digital assistant (PDA) 200 can display the shortcut numbers 120 as illustrated in FIG. 38. In FIG. 38, parts that are the same as the parts illustrated in FIG. 6 are indicated by the same reference numerals, and a description thereof is omitted.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal device comprising:
a control unit configured to execute a process including
acquiring data having anchors that are link information that is linked to other data,
specifying an anchor that is included in a display range among the acquired anchors, and
editing data that is to be displayed and includes the specified anchor to which a shortcut is assigned.

2. The mobile terminal device according to claim 1, further comprising:
a display unit configured to display the edited data.

3. The mobile terminal device according to claim 1, wherein
the control unit executes the process on the basis of a change in the display range.

4. A computer-readable recording medium that stores a data display program, the data display program makes a mobile terminal device execute a process comprising:
acquiring data having anchors that are link information that is linked to other data,
specifying an anchor that is included in a display range among the acquired anchors, and
editing data that is to be displayed and includes the specified anchor to which a shortcut is assigned.
